(19) United States
(12) Patent Application Publication
(10) Pub. No.: US 2009/0132395 A1
(43) Pub. Date: May 21, 2009

(54) USER PROFILING IN A TRANSACTION AND ADVERTISING ELECTRONIC COMMERCE PLATFORM

(75) Inventors: Lawrence Lam, Bellevue, WA (US); Brad W. Ward, Seattle, WA (US); Arun Sacheti, Sammamish, WA (US); Richard Jon Gruenhagen, Woodinville, WA (US); Sterling David Sessions, JR., Laguna Hills, CA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 12/145,172

(22) Filed: Jun. 24, 2008

Related U.S. Application Data
(60) Provisional application No. 60/988,150, filed on Nov. 15, 2007.

(51) Int. Cl. G06Q 10/00

(52) U.S. Cl. 705/30

(57) ABSTRACT

The subject disclosure relates to electronic commerce and advertising platforms that aggregate transaction data from merchants and consumers. A set of enhanced scenarios built on the platform span both the online and offline transactional and advertising universe to the benefit of all participants of the electronic commerce and advertising platform. In non-limiting embodiments, user profiling is performed across multiple data providers that can infer additional profiling information from different transaction data sources, and can take into account a confidence associated with transaction data when updating a user profile, e.g., where data elements of given transaction data may be incomplete, missing or uncertain.

### RELATED APPLICATION

The present application claims priority under 35 U.S.C. §119(e) to U.S. Provisional Patent Application Ser. No. 60/988,150, filed Nov. 15, 2007, entitled “TRANSACTION AND ADVERTISING ELECTRONIC COMMERCE PLATFORM”, the entirety of which is incorporated herein by reference.

### TECHNICAL FIELD

The subject disclosure relates to transaction and advertising platforms, and subsystems thereof, one or more parts of which profile users, or user identifications, based on user transactions aggregated from multiple data providers in the platform ecosystem.

### BACKGROUND

By way of background concerning conventional systems, typical transaction and advertising platforms have been proprietary and myopic. By their very nature, capturing only a small amount of user transactions and information from a limited set of merchants, the current picture of users applied by existing advertising networks is not far reaching enough to provide relevant advertisements at the user level. While groups of people who enjoy “sports” can be identified from some generalized behavior, the information is not granular enough to be of particular relevance to any one user within the overall group. As a result, the advertising targeting experience today serves more to annoy users with spam like targeting of irrelevant advertisements, turning the whole purpose of such systems on its head. In addition, the reach of conventional systems tends to be limited to specific on-line transactions.

Accordingly, it would be desirable to provide an improved transaction and advertising platform for enriching a host of consumer experiences in both the online and offline world, such that, among other things, consumers, merchants and advertisers alike more willingly participate due to the increased relevance of content and use of their data. As part of these and other goals, it would be desirable to provide better ways to identify users based on user information in the advertising and transaction ecosystems, which may be provided from a variety of data providers, even where the data may not be trusted.

The above-described deficiencies of today's advertising platforms and transaction tracking systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Various embodiments of an improved electronic commerce and advertising platform are described that aggregate transaction data from merchants and consumers and that provide increased visibility into user data across different providers in the system. A set of enhanced scenarios are enabled that span both the online and offline transactional and advertising universe to the benefit of all participants of the electronic commerce and advertising platform.

In various non-limiting embodiments, an ID mapping component provides a process to pin identifiers from multiple data providers to a single user profile. A fuzzy profiling component and process can store and make use of uncertain information to contribute to the building of user profiles. The fuzzy profiling component also provides a way to query those user profiles taking into account levels of uncertainty through confidence scoring. In other embodiments, data augmentation is enabled in order to enrich data stored by the platform through inferences and acquired knowledge drawn from the original source data.

Further embodiments are described below.

### BRIEF DESCRIPTION OF THE DRAWINGS

Various non-limiting embodiments are further described with reference to the accompanying drawings in which:

FIG. 1 illustrates a method for mapping raw transactional data to unique user identities for an ecommerce platform;

FIG. 2 is a flow diagram illustrating an exemplary, non-limiting process for generating a user profile from aggregate transaction data;

FIG. 3 illustrates another non-limiting embodiment of an electronic commerce platform;

FIG. 4 illustrates another non-limiting embodiment of an electronic commerce platform;

FIG. 5 is a flow diagram illustrating an exemplary, non-limiting process for generating a user profile from aggregate transaction data;

FIG. 6 illustrates another non-limiting embodiment of an electronic commerce platform;

FIG. 7 is a flow diagram illustrating an exemplary, non-limiting process for aggregating user transaction data from users and determining user profiles from the user transaction data for use in connection with customizing network services;

FIG. 8 illustrates another non-limiting embodiment of an electronic commerce platform;

FIG. 9 is a flow diagram illustrating an exemplary, non-limiting process for aggregating user transaction data from users from different data sources;

FIG. 10 illustrates an embodiment of an electronic commerce platform for aggregating user transaction data;

FIG. 11 illustrates a general process for a user to control the use of the user's data in connection with an electronic commerce platform;

FIG. 12 represents a non-limiting architecture for the various embodiments of an ecommerce platform;

FIG. 13 represents a non-limiting data flow diagram for illustrating a flow of data in an ecommerce platform according to one or more of the embodiments described herein;

FIG. 14 represents another non-limiting data flow diagram describing how transaction data is received, processed and otherwise handles to enable a host of rich scenarios;

FIG. 15 is an exemplary non-limiting screenshot of a map scenario enabled by the rich user profile metadata available to applications and services as a result of one or more embodiments of an ecommerce platform described herein;

FIGS. 16 to 18 are exemplary non-limiting block diagrams of implementations of one or more aspects of an ecommerce platform according to one or more embodiments of an ecommerce platform described herein;

FIG. 19 is an exemplary non-limiting block diagram of an implementation of one or more intelligent aspects of a merchant descriptor processing system;

FIG. 20 is a block diagram representing an exemplary non-limiting networked environment in which embodiment(s) may be implemented; and

FIG. 21 is a block diagram representing an exemplary non-limiting computing system or operating environment in which aspects of embodiment(s) may be implemented.

### DETAILED DESCRIPTION

### Overview

As discussed in the background, among other things, current proprietary transaction and advertising ecommerce platforms are limited by their reach ending up doing more harm than good to participants resulting from the low relevance of results, or other poor quality associated with the results. Also, conventional transaction electronic commerce platforms that attempt to track user data do not adequately address conflicting or otherwise uncertain user data. Systems tend to either trust or not trust the data as a strict dividing line, but do not consider uncertain levels of trust, e.g., do not consider how much confidence there is in the data by the system. At least partly in consideration of these deficiencies of conventional advertising platforms, various embodiments of an improved electronic commerce and advertising platform are described herein that aggregate transaction data from merchants and consumers.

A set of enhanced scenarios predicated or built on the platform can span both the online and offline transactional and advertising universe to the benefit of all participants of the electronic commerce and advertising platform. Various embodiments of the subject disclosure are next presented for illustration of one or more aspects of the platform, followed by some exemplary, non-limiting optional implementations and environments for supplemental context and understanding.

While each of the various embodiments below are presented independently, e.g., as part of the sequence of respective Figures, one can appreciate that an integrated transaction and advertising platform, as described, can incorporate or combine two or more of any of the embodiments. Given that each of the various embodiments improve the overall health and quality of the data in a transaction and advertising platform, together a synergy results from combining different benefits when a critical user adoption mass is reached. Specifically, when a transaction and advertising platform provides the cross benefits of different advantages, features or aspects of the various embodiments described herein, users are more likely to use such a beneficial platform. As a generally recognized relationship, the more likely users will be to use, the more the advertising platform will gain critical mass according to the so-called network effect of adoption. Any one feature standing alone may or may not gain such critical mass, and accordingly, the combination of different embodiments described below shall be considered herein to represent a host of further alternate embodiments.

In various embodiments, an electronic transaction data platform includes an ID mapping component that uses algorithms to pin identifiers from multiple data providers to a single user profile, sometimes from explicit user provided data and/or from transactional data. In addition, the platform can include a fuzzy profiling system that stores and makes use of uncertain information to contribute to the building of user profiles. The fuzzy profiling system can include the ability to query those profiles taking into account levels of uncertainty through confidence scoring.

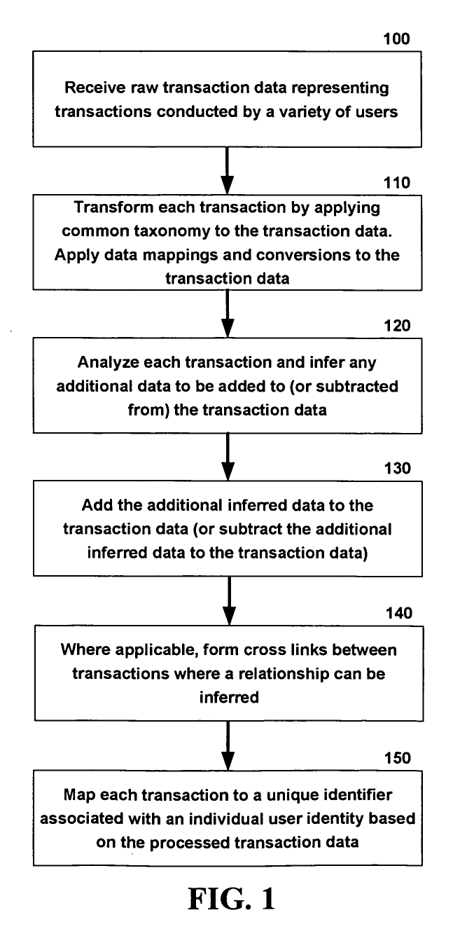

For instance, FIG. 1 illustrates a method for mapping raw transactional data to unique user identities. At 100, different data providers in the system provide raw transaction data representing transaction data from one or more transactions conducted by a variety of users. At 110, for each transaction represented by the transaction data, the transaction is transformed by applying at least one common taxonomy to the transaction data including applying preset data mappings and conversions to the transaction data. At 120, each transaction is analyzed and any additional data inferred from the normalized data is added to the transaction data associated with the transaction. At 130, any additional inferred data can be added to the transactions data to form processed transaction data. At 140, optionally, where a relationship between the transactions can be inferred, a cross linking step is performed between transactions of the processed transaction data. At 150, each transaction is mapped to a unique identifier associated with an individual user identity based on the processed transaction data. In this fashion, irrespective of the source of data, a user's transactions across different merchants, both online and offline, can become a unified part of the user's profile.

For instance, it might be found that a given consumer has purchased a Coleman stove, a sleeping bag, a tent, and a canister of bug repellent. The system could thus conclude or infer that the consumer likes to go camping, and add the additional information about the camping category to the user profile as part of the mapping process.

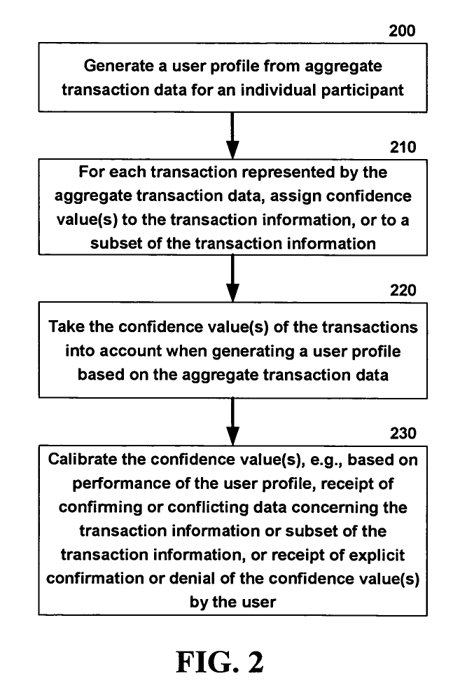

FIG. 2 is a flow diagram illustrating an exemplary, non-limiting process for generating, at 200, a user profile from aggregate transaction data for an individual participant in an electronic commerce and advertising platform based on confidence degrees, levels or values associated with the underlying data. At 210, for each transaction represented by the aggregate transaction data, confidence value(s) are assigned to the transaction information, or to a subset of the transaction information. At 220, the confidence value(s) are taken into account when generating a user profile based on the aggregate transaction data. At 230, the confidence value(s) can be calibrated based on (a) actual performance of the user profile, i.e., feedback that validates the user profile information, (b) receipt of additional confirming or conflicting data concerning the transaction information or subset of the transaction information or (c) receipt of explicit confirmation or denial of the confidence value(s) by the user represented by the user profile.

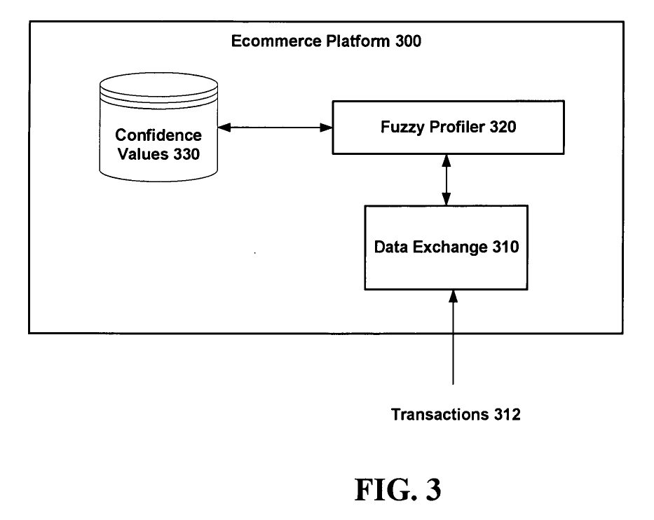

FIG. 3 illustrates another non-limiting embodiment of an electronic commerce platform 300. Electronic commerce platform 300 comprises a data exchange 310 for aggregating user transaction data from transactions 312 conducted by users. A fuzzy profiler 320 communicatively coupled to data exchange 310 assigns confidence values 330 to the user transaction data, or to data elements underlying the user transaction data, based on degrees of certainty associated with the transaction data or data elements. The fuzzy profiler 320 takes the confidence values 330 into account when forming or updating a user profile for the user such that a user profile is formed or updated despite data elements of transactions being uncertain, incomplete or missing. The fuzzy profiler 320 can assign confidence values 330 in part based on a confidence with a source of the user transaction data, or a source of the data elements of the user transaction data.

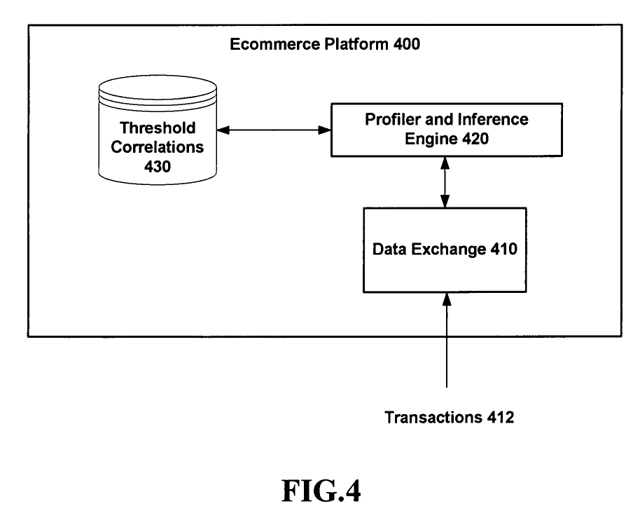

FIG. 4 illustrates another non-limiting embodiment of an electronic commerce platform 400. Electronic commerce platform 400 includes a data exchange 410 for aggregating user transaction data 412 conducted by a user of the electronic commerce platform 400 and a user profiler 420 communicatively coupled to the data exchange 410 that automatically augments a user profile for the user if at least one threshold correlation 430 is present among a set of transactions of the user transaction data 412, whereby the user profiler 420 infers preferences of the user based on an analysis of correlated transactions and augments the user profile for the individual participant to include the preferences.

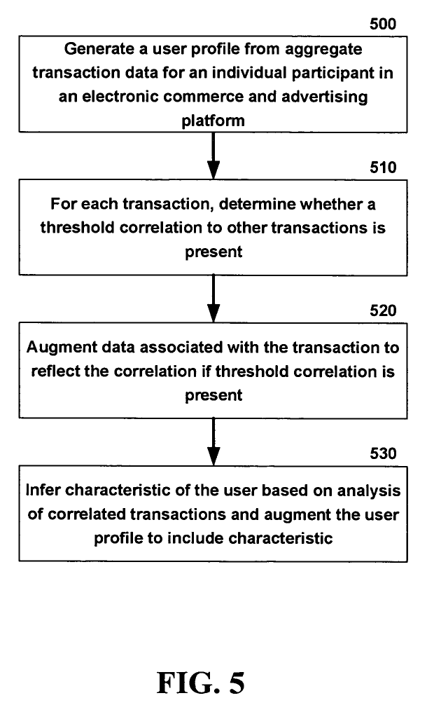

FIG. 5 is a flow diagram illustrating an exemplary, non-limiting process for generating, at 500, a user profile from aggregate transaction data for an individual participant in an electronic commerce and advertising platform. At 510, for each transaction represented by the aggregate transaction data, it is determined whether threshold correlation(s) to other transaction(s) by the individual participant is present. If, at 520, the threshold correlation(s) are present, the data associated with the transaction is augmented to reflect the correlation. At 530, characteristic(s) of the user are inferred based on an analysis of correlated transactions and the user profile for the individual participant is augmented to include the characteristic(s).

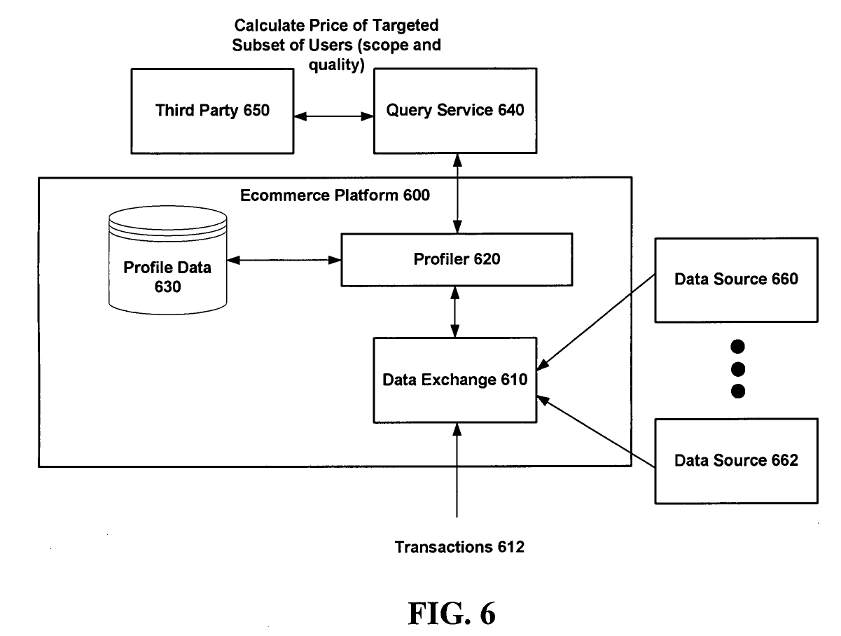

FIG. 6 illustrates another non-limiting embodiment of an electronic commerce platform 600. Electronic commerce platform 600 includes a data exchange 610 for aggregating user transaction data 612 from transactions conducted by users. Data exchange is further populated by other data sources 660 to 662. A user profile component 620 forms user profiles from the data exchange 610 and stores the user profiles in store 630. A user profile query service 640 communicatively coupled to the data exchange 610 presents a subset of users in response to a query from a third party 650 for a targeted subset. Optionally, a monetization component of the query service 640 calculates the price of the subset of users to the third party 640 based on a scope of users identified in the query and confidence information associated with the user profiles represented by the subset of users. As a result, monetization of the data represented in the platform 600 is fairly mapped to richness of the data as well as to the quality of the data. For example, a query that returns “females in WA” may cost $2 per thousand, but a query that returns “females who bank online” may cost $20 per thousand.

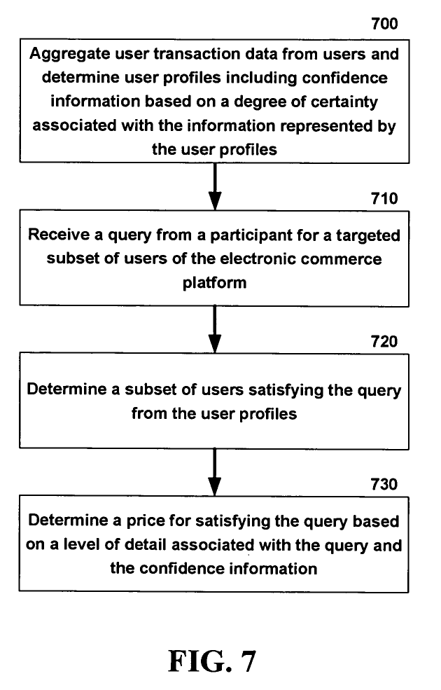

FIG. 7 is a flow diagram illustrating an exemplary, non-limiting process for aggregating user transaction data from users and determining user profiles from the user transaction data for use in connection with customizing network services. At 700, confidence information is associated with the user profiles based on a degree of certainty associated with the user information represented by the user profiles. At 710, a query is received from a participant for a targeted subset of users of the electronic commerce platform. At 720, a subset of users is determined as satisfying the query from the user profiles. At 730, a price for satisfying the query is determined based on a level of detail associated with the query and the confidence information associated with the user profiles represented by the subset of users.

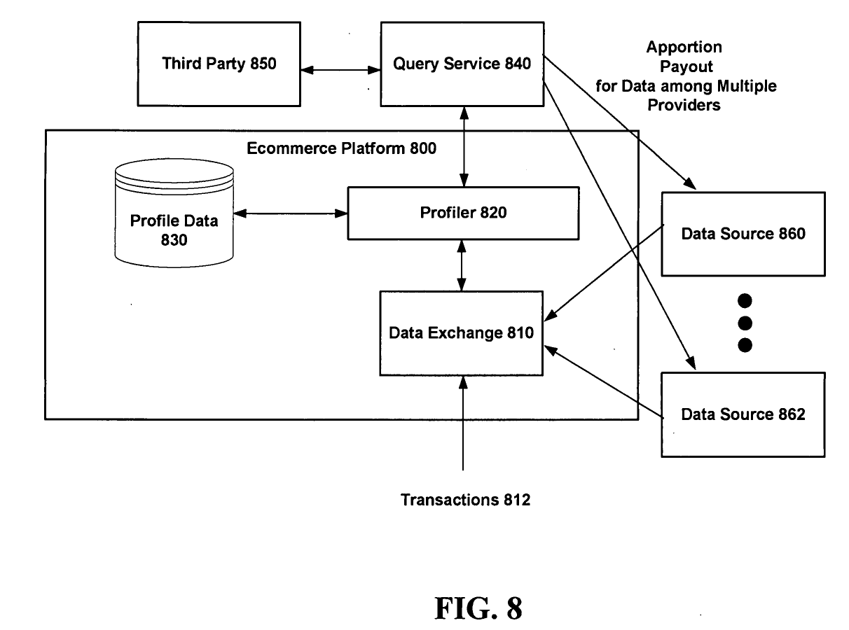

FIG. 8 illustrates another non-limiting embodiment of an electronic commerce platform 800. Electronic commerce platform 800 includes a data exchange 810 for aggregating user transaction data 812 from transactions conducted by users. Data exchange is further populated by other data sources 860 to 862. A user profile component 820 forms user profiles from the data exchange 810 and stores the user profiles in store 830. A user profile query service 840 communicatively coupled to the data exchange 810 presents a subset of users in response to a query from a third party 850 for a targeted subset. Optionally, a monetization component of the query service 840 determines whether any of the data sources 860 to 862 for the data underlying determination of the subset of users provided overlapping data and if so, the monetization component apportions a payout amount to the data sources providing overlapping data in proportion to quality metrics associated with the data sources. Those sources known to provide reliable data are thus paid better, and thus a natural incentive is built into the platform 800 to provide quality, trusted data. For example, a payment provider, a merchant, and the consumer all contribute data points that conclude a certain characteristic about them (they live in the same city). The monetization algorithm can thus apportion credit for the conclusion back to the data sources according to the certainty of their data.

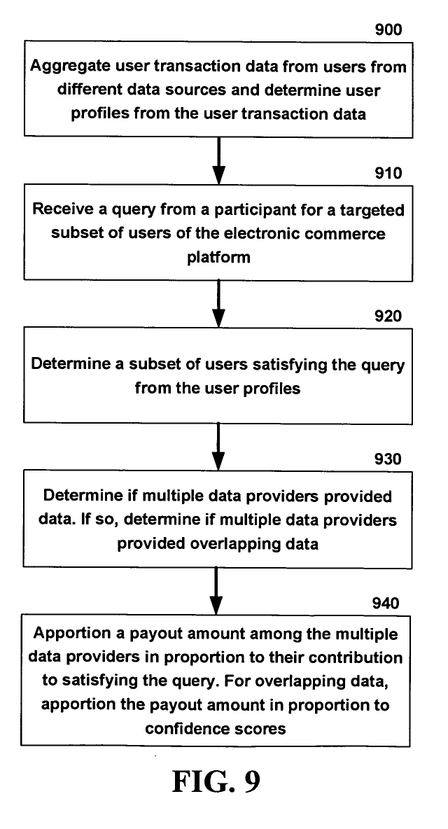

FIG. 9 is a flow diagram illustrating an exemplary, non-limiting process for aggregating, at 900, user transaction data from users from different data sources and determines user profiles from the user transaction data for use in connection with customizing network services. At 910, a query is received from a participant for a targeted subset of users of the electronic commerce platform. At 920, a subset of users is determined as satisfying the query from the user profiles. At 930, it is determined if multiple data providers provided the data underlying satisfaction of the query. If so, at 940, a payout amount is apportioned among the multiple data providers in proportion to their contribution to satisfying the query. For instance, where overlapping data (i.e., the same or substantially the same data) is provided by multiple data providers, then the payout amount is apportioned based on confidence scores associated with the overlapping data as provided by each of the multiple data providers.

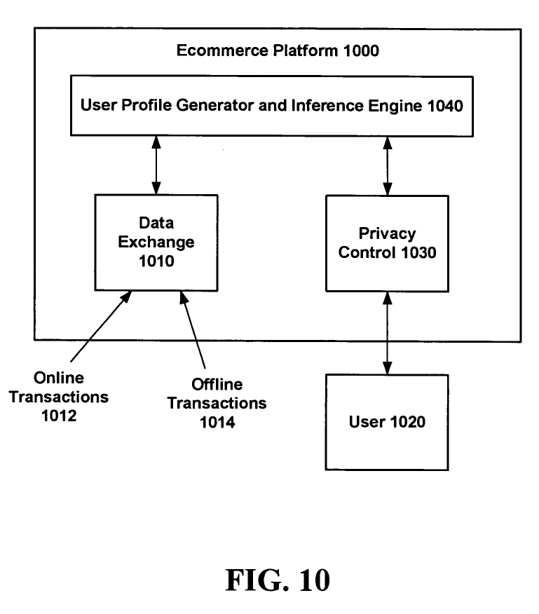

In one embodiment, as illustrated in FIG. 10, an electronic commerce platform 1000 is provided that includes a data exchange 1010 for aggregating user transaction data from online transactions 1012 and/or offline transactions 1014 conducted by users 1020. Optionally, a privacy control component 1030 enables individual users, such as user 1020, explicit control over the further use of the individual user's transaction data beyond aggregating by the data exchange 1010. The platform 1000 includes an inference engine 1040 for generating user profiles on a per user basis from the user transaction data based on queries subject to the limits placed on use of user transaction data via the privacy control component 1030.

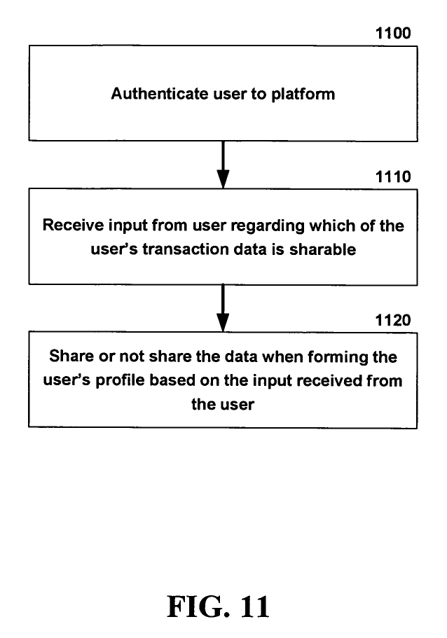

FIG. 11 illustrates a general process for a user to control the use of the user's data in connection with an electronic commerce platform that aggregates user transaction data from users and determines user profiles from the user transaction data for use when providing and customizing network services, such as, but not limited to, advertising services. After authenticating a user to validate the user's identity with respect to the electronic commerce platform at 1100, input is received from the user at 1110 regarding sharable data categories pertaining to the user's transaction data. At 1120, only the sharable data categories are used in connection with forming the user's profile. In this fashion, users possess explicit control over how their data is used and, as a result, are more likely to participate in the system versus not participating at all where there is no explicit control.

### Enhanced Advertising and Transaction Platform

In a variety of embodiments described above, user profiling is performed that augments user profiling data by inference when incorporating transaction data from variety of different data providers, and under circumstances where one or more data elements of the user data at issue may be uncertain, incomplete or missing. In various non-limiting embodiments, a transaction and advertising platform is in turn described below that can incorporate the above techniques, though it can be appreciated that such implementation is optional and that the techniques can be applied with efficacy in a variety of integrated transaction and advertising platforms.

In one embodiment of a transaction and advertising platform, the platform collects and aggregates transaction and identity profile data in order to drive targeting of advertising and to improve search relevance. A comprehensive commerce transaction platform, by virtue of its support of both network transactions and services as well as traditional retail transactions, is attractive to service providers, merchants and consumers, which then bolster the population of the ecosystem so that the vision is realized. Various scenarios can then be realized due to the comprehensive nature of the transaction and advertising platform by providing end users with a “My Commerce” view of advertising transactions.

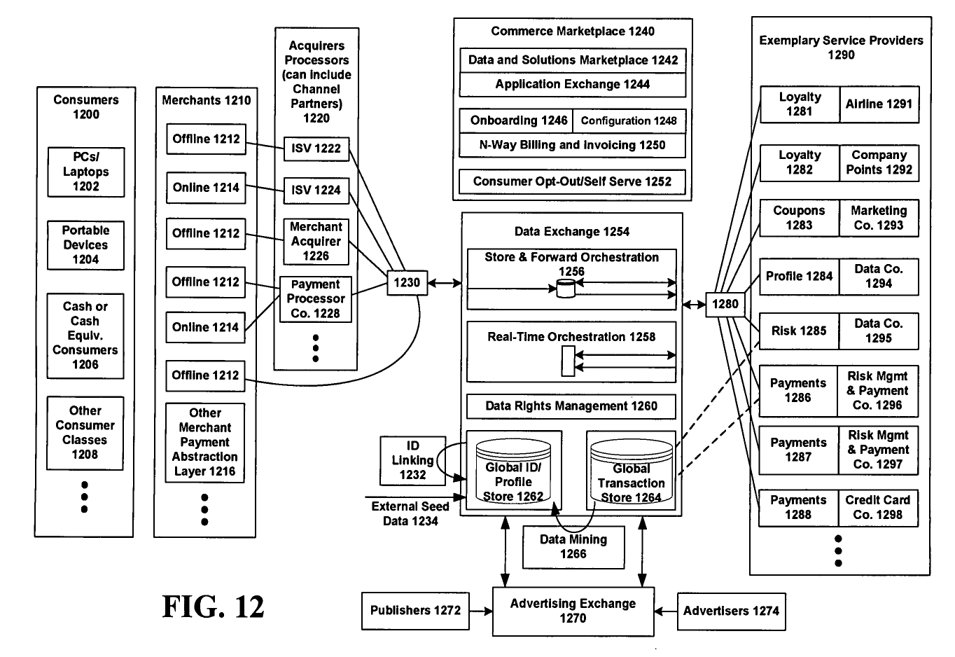

FIG. 12 illustrates an exemplary, non-limiting implementation of one or more aspects of the embodiments described herein. Consumers 1200 include PCs/laptops 1202, portable devices 1204, cash or cash equivalent consumers 1206 and other consumer classes 1208. Consumers 1200 make online 1212 or offline 1214 purchases from merchants 1210. Other payment abstraction layers 1216 can also be accommodated by the architecture. Merchants 1210 can process their own transactions or often they are processed by acquirers/processors 1220, which can include channel partners. This includes independent service vendors (ISVs) 1222, 1224, a merchant acquirer 1226, or ecommerce and payment services company 1228. The transaction data is then input to the data exchange 1254 via network 1230, either directly or indirectly as shown.

Ecommerce marketplace 1240 includes a data and solutions marketplace 1242 and an application exchange 1244 for implementing outward facing solutions to data providers, merchants and consumers of the data of ecommerce marketplace 1240. Marketplace 1240 may further include an outboarding component 1246 as well as a configuration component 1248. An n-way billing and invoicing component 1250 advantageously can apportion pricing or payments according to quality of the value add received or provided. A consumer opt-in/opt-out component 1252 enables consumers control for how their data is used, and thus ultimately how the system can target them to their benefit as opposed to the sole benefit of merchants.

Data exchange 1254 includes store and forward orchestration component 1256 for handling end-to-end communications in the marketplace. In some cases, orchestration is provided in real time by component 1258 where an application or service benefits from real time performance. A data rights management component 1260 enables consumer/user control over the use of and access to their data for targeting purposes, i.e., user data will not be accessible except as permitted by the user. Two stores, a global ID/profile store 1262 and a global transaction store 1264 form the basis form the basis for many of the applications, services and scenarios described herein. The databases 1262 and 1264 can be seeded externally as represented by arrow 1234, and where the data in stores 1262, 1264 is to be correlated, linking component 1232 can handle the linking analysis and process. On top of the stores 1262, 1264 is a data mining component that performs comprehensive analysis of data correlations in stores 1262, 1264 for inferencing, augmenting and the like.

Advantageously, due to the breadth of the data stored in stores 1262, 1264, an advertising exchange 1270 can benefit from the power of the data, thereby attracting advertisers 1274 and publishers 1272 to the powerful underlying data, enriching the entire advertising ecosystem by bringing more relevant and more desirable advertisements to end users, and bringing more value and less waste to advertising entities 1274 and publishing entities 1272 as well.

Via one or more networks 1280, various service providers 1290 can also leverage the power of data exchange 1254. For instance, loyalty program 1281 of airline 1291, loyalty program 1282 of company 1292, coupons 1283 of marketing company 1293, profiles 1284 of data company 1294, risk information 1285 of data company 1295, payment information 1286 of risk management and payment company 1296, payment data 1287 of risk management and payment company 1297 and payment data 1288 of credit card company 1298 are only a few examples of the kinds of services and programs that can be made more powerful by tapping into the powerful data represented in data exchange 1254.

The transaction and advertising platform can collect transactional data from service providers and merchants with the explicit consent of consumers. In one embodiment providing varying or fixed degrees of control to consumers to address privacy concerns, consumers can be in partial or total control of the rights granted to their transactional data. The user rights granted can correspond with the richness of their user experience provided by the customer scenarios that can be enabled based on this data.

From a variety of disparate transaction sources, the transactional data can be collected and processed into a standardized and consumable format that is mapped to a particular user identifier. This data can also be amalgamated to construct user profiles that include valuable inferences about a consumer based on their transactional data and supplementary data supplied by service providers and the users themselves.

This data can be consumed by a variety of actors in the advertising ecosystem in order to realize the additional value that the transactional and profile data brings to a variety of services.

As to source data for the platform, with various embodiments of the transaction and advertising platform described herein, one aspect is building profiles based on a consumer's disparate types of purchasing activities. In this regard, parties such as payments providers, e.g., debit and credit card issuers, can provide data that includes one or more of the following attributes of a consumer's purchasing activity: Payment Instrument, Number, Transaction Amount, Date of Transaction, Merchant Name, Merchant Location (City, State, Zip) and Merchant Category Code.

In some cases, data can also be captured from some payment providers, as well as from loyalty networks, such as Aeroplan, Starwood, or the like, and vendors with their own proprietary loyalty programs, e.g., grocery stores such as Safeway. Such data can include the following attributes in addition to typical attributes: Item Product Code, Item Description and Item Price and Extended Amount.

This data can also be collected directly from vendors plugged into the transaction and advertising platform via a direct interface, such as via secure APIs that enable access to qualified vendors. The data can also be collected via merchant networks and acquirers, or directly from the consumers themselves. Data received from multiple sources can also be used to validate the data or bolster a confidence level associated with the data.

Moreover, additional supplementary profile information, such as demographic and preferences data, may be supplied by the consumers, Behavioral Targeting, and via profilers, like Experian or Equifax.

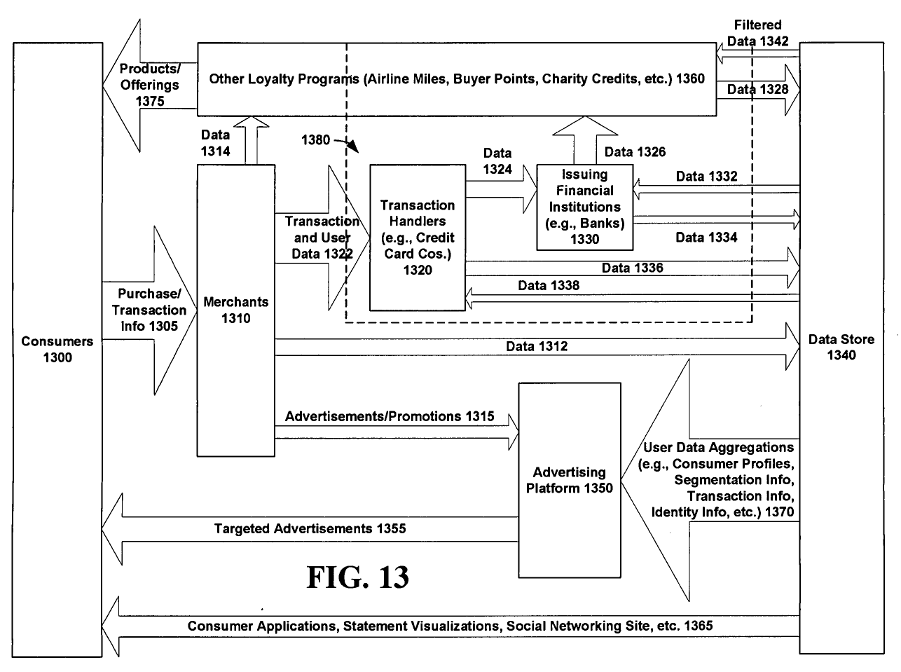

The transactional data can always be visible and under full access control of the consumers. The profiles built by the data can be queryable for the purposes of ads and commerce targeting, as discussed in greater detail in the next section. The various levels of data and data flow are illustrated in representative, non-limiting fashion in FIG. 13. As illustrated, with consumers 1300 on the left side, consumers in various fashions send purchase/transaction information 1305 to merchants 1310, e.g., by acting to make purchases. Merchants then also acquire transaction and user data 1322 as part of the purchasing process, which can be sent to transaction handlers 1320, e.g., credit card companies, who carry out one or more financial aspects of the transaction. Transaction handlers 1320 also acquire or augment data as part of sending data 1324 to issuing financial institutions 1330, e.g., banks. A data store 1340, represented as an abstraction, then aggregates the various information received from consumers 1300, merchants 1310 via data 1312, transaction handlers 1320 via data 1336 and issuing financial institutions 1330 via data 1334. In addition, merchants 1310 and issuing financial institutions 1330 can also send data to loyalty programs 1360 via data 1326 and data 1314, respectively. Merchants 1310 can also send information about advertisement and promotions 1315 to an advertising platform 1350.

The power of such a data store 1340 is realized via the flow in the other direction. In this regard, various user data aggregations 1370, such as consumer profiles, segmentation information, transaction information, identity information, etc. can be sent to advertising platform 1350 to enhance relevance, reach, conversion rates, etc. associated with advertising transactions undertaken via platform 1350. As a result, more targeted advertisements 1355 reach consumers via data 1355. Moreover, data store 1340 can be realized directly by consumers 1300 via services 1365 offered directly to consumers 1300, including, but not limited to, various consumer applications, e.g., financial applications, statement visualizations, social networking sites, etc.

Data store 1340 can also be used to retrieve data 1338, which can be used by transaction handlers 1320 for a variety of tasks, e.g., fraud protection by analyzing a departure in user signature, transaction history, geographical impossibility, etc. Issuing financial institutions can similarly benefit by data 1332 from data store 1340 for a variety of its services as can loyalty programs 1360 benefit from filtered data 1342 output from data store 1340. As a result, the loyalty programs 1360 can better target customers 1300 and send more relevant products and offerings 1375 to consumers 1300. Thus, the ecommerce platform interrelates participants and the flow of data surrounding users and purchases to form an aggregate data store, from which all participants can also benefit, since data store 1340 contains more information than any one participant alone possesses.

With respect to platform product, two of the assets of value produced by the various embodiments of the transaction and advertising platform described herein are a set of transformed and consumable transactional data, and user profiles constructed primarily from the transactional data. As described herein, the profile data can be an amalgamation of transaction data with data from other sources. This data can be further enriched by making inferences on the data at varying degrees of confidence about the user or household.

Each profile attribute can comprise (A) where it sits in the structured or hierarchical taxonomy, e.g., Profile, Lifestyle, Interests, Games, Chess, etc., (B) value(s) with confidence levels expressing how likely the given value is correct, e.g., 0 to 100% confidence, (C) usage metrics expressing how valuable that data point has been, e.g., correlation statistics indicating whether the data point should be maintained, (D) source information, i.e., from where the information originated, which may include multiple and/or conflicting values, (E) usage rights, (F) authorization information, e.g., who is able to access this information and who is not able to access it, (G) platform cost value—a price tag placed on the use of this metric by the platform and (H) source cost—a price tag placed on the use of this metric by its source and/or (I) whether the data point is a statement of fact, a user-sourced statement of preference, or inferred values, etc.

Statements of facts, e.g., the particular consumer has 2 kids, and user-sourced statements of preferences, e.g., likes lifestyle food and music, may be presented to the user for correction(s). Inferred values, such as VALS2 group, etc., are work product of participating companies, non-factual and need not be presented to users who would not understand them anyway.

By mapping the transactional data to unique identities, profiles can be constructed on each unique identity, whether that is an individual consumer, a particular household, or group of people (e.g., a collection of profiles from a social network). The standardized transactional data as well as the resultant profile data of the data exchange, with the explicit consent of the user, can be consumed by the advertising exchange to improve the relevancy and targeting of ads delivered to the user. This provides a personalized end user experience in the ads and social networking space.

An advertiser can define its own target segment by constructing a query based on characteristics in which it is interested and submit that query to the transaction and advertising platform. The transaction and advertising platform then identifies the users that match the target characteristics and submits the users to the advertising exchange to match those users with the advertisement. The specific identities of the user list are not revealed to advertiser in order to protect the consumer's personal data from exposure.

The output of a query can include: (A) a reference to a ‘list’ which can be used for online targeting purposes, or provided to participating mailing houses, etc. (this list is not given to the merchant), (B) the number of matches, (C) the quality of matches based on quality of information used in include/exclude decisions (this information can be used to rank placement, e.g., the more confident about user A, the more ads as well as better ads in front of user A), (D) the cost of executing the query, based on the value of variables used and/or (E) non-identifying information on the return set such as other characteristics.

Queries can also be monetized as a secondary product in an advertising query marketplace. This allows experts, such as marketing professionals, to prepackage complex queries to be made available to merchants. This can manifest as a dynamic ‘mailing list,’ which could be used for advertising targeting online and potentially offline as well. In one embodiment, identifying information on members of that list is not provided to advertisers, such as merchants, and remains property of platform, which is heavily secured against third party discovery.

A query using commodity information, such as geographic state, may be priced much lower than queries based on more domain specific/infrequent information such as use of financial services. Overall cost of a query is generally a factor of each variable used, and for each variable, the number of matches, the cost of that data point, and commission to the source, quality of matches etc. As a non-limiting example, an advertisement targeted at females in Washington state may cost $2 per thousand, whereas ads targeted at females who bank online may cost $20 per thousand.

The platform provider can also provide a simple set of APIs for application developers to query the transaction and advertising platform for profile and transaction information about a given user in order to promote the development of compelling user experiences that drives adoption and usage of the platform and to enrich the raw transactional data. Some reference applications that would make use of these APIs are described briefly in a later section.

With respect to information flow, once a user is enrolled into the transaction and advertising platform ecosystem, the service providers linked with that user are then authorized to send transactional and other profile related information to the transaction and advertising platform system. Upon collection of transactional data, this data can be transformed according to the following steps:

First, raw transactional data is received in a central staging area. Transactional data rows are then transformed individually by applying common sets of taxonomies, data mappings and conversions. Additional inferred data can be added to the transactional rows for data completeness and enrichment. Cross linking between transactions is performed, if useful and applicable. Transactions are then mapped to explicit consumer identifiers. These rows then constitute the standardized transaction data. The standardized transaction data can be augmented or corrected via user input. The transaction data can also be fed into the User Profile Store to build up a user's profile. Additional data mining and processing on the data combined with third party data, e.g., from Behavioral Targeting, Experian, etc., can further enhance the User Profile Store.

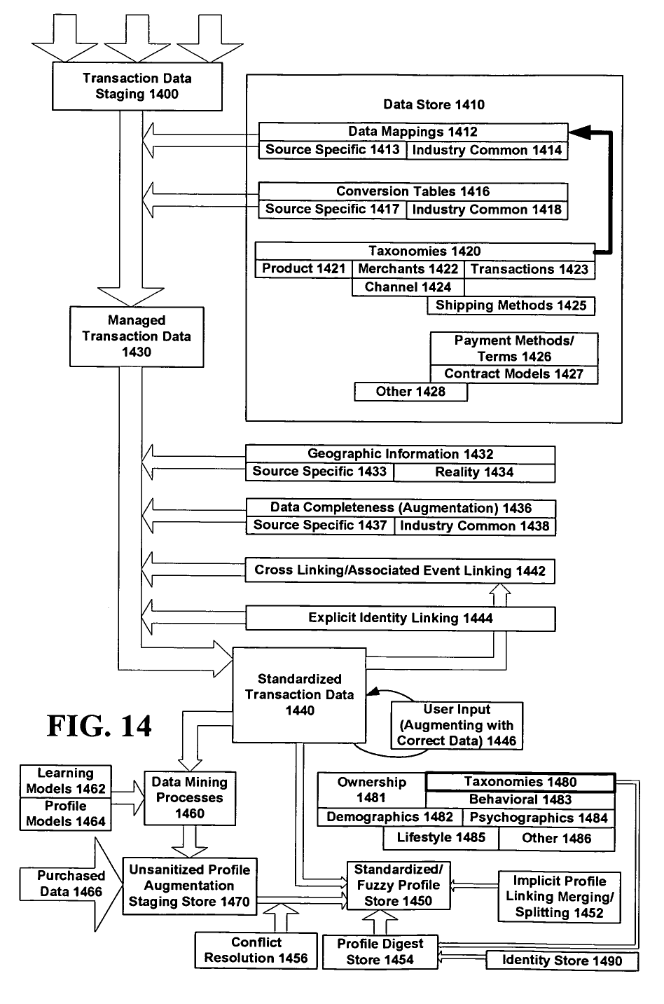

Various aspects of a non-limiting implementation of this additional processing are represented in the flow diagram in FIG. 14. As mentioned, initially, the system receives raw transactions data at 1400 according to the various participants in the ecosystem. The raw data 1400 is then transformed so that data from disparate sources can be more meaningful under a common view. Thus, with reference to a data store 1410, data mappings 1412, which can be source specific 1413 or common to an industry 1414, can be applied to the data 1400. Additionally, various taxonomies 1420 can be received as input to the data mappings 1412. For instance, taxonomies 1420 can include various classifications relating to products 1421, merchants 1422, transactions 1423, channels 1424, shipping methods 1425, payment methods or terms 1426, contract models 1427, or any other taxonomy 1428 input to taxonomies 1420 for use during data mapping 1412.

Conversion tables 1416 can also be applied, which may also be source specific 1417 or industry common 1418, so that measurements, standards, protocols, etc., can be understood in an apples-to-apples fashion. Once these transformations are applied to the data 1400, managed transaction data results 1430 can then be further enhanced as follows. For instance, data 1430 can be enhanced with geographic information 1432, which can be source specific 1433 or reality based 1434 (e.g., address or position on Earth). A data completeness or augmentation module 1436 can fill in any blanks in data, or otherwise add useful properties to the data, which can be source specific 1437 or industry common 1438 ways of augmenting the data 1430. A cross linking or associated event linking module 1442 can further enhance the data by identifying cross-correlations among disparate items of recorded data. Then, explicit identity linking 1444 can be performed where an identity is explicitly known and data is already explicitly known that about an identity that can enhance the data 1430.

Standardized transaction data 1440 can also be fed back to cross linking/associated event linking component 1442 to increase the performance of the effort by making more information about the past available. Standardized transaction data 1446 can also be further enhanced by a user at 1446 by the user augmenting the data with correct data. After enhancement, standardized transaction data 1440 is ready for further processing and mining 1460. Various learning models 1462 and profile models 1464 can improve the performance of the data mining processes 1460 by extracting information that is more relevant. The output of data mining processes 1460 can be input to an unsanitized profile augmentation staging store 1470 into which data 1466 about past purchases is input. Invariably, a conflict may be detected in user data where resolution is required as applied by conflict resolution component 1456. The result is then fed to a standardized/fuzzy profile store 1450, which represents user profiles efficiently.

Fuzzy profile store 1450 also includes input from standardized transaction data 1440 and to profile digest store 1454 for additional understanding of users. An implicit profile linking merging/splitting module 1452 can help the fuzzy profile store 1450 form a single profile for each user rather than represent users in a fragmented or duplicative manner. As input to profile digest store 1454, an identity store 1490 coupled with a host of taxonomies 1480 (e.g., ownership 1481, demographics 1482, psychographics 1484, lifestyle 1485, or other taxonomies 1486) can inform profile digest store 1454 with respect to classes of users to track.

Regarding user consent and access permissions, explicit consent from the consumers for their data to be used in the first place goes hand-in-hand with the profile and transactional data. Without providing for the need for explicit consent of the user, the transaction and advertising platform would not be able to provide a trustworthy user experience. With a robust access control interface for the user to control, the transaction and advertising platform can also act as an advocate for the user's online privacy and help to reinforce the platform provider's position as a leader in online security and privacy at a time when various Internet companies are continuing to mount threats to viability of preservation of privacy.

A user consent and access permissions component provided for the platform can: (A) prohibit sharing of highly sensitive PII/not share by default purchases classified as “sensitive,” e.g., gambling, medical, etc., (B) allow the user to set a cooling-off period, i.e., a fixed amount of time before transactional data can be shared or used to build the user profile, (C) include a portal available for the user to review all transactional data and from where the user can choose to individually share or unshare data, which choices then propagate to the profile level and/or (D) learn what types of transactions are not shared and automatically unshare them by default in the future.

The user consent component is one example of attracting entities to the transaction and advertising platform to achieve critical mass, i.e., the user consent component provides a strong value proposition to compel the users to participate in the ecosystem. With consumers sharing only that part of themselves that they wish to share, consumers are incentivized to join the ecosystem. In addition, the transaction and advertising platform provides incentives for merchants as well as the various entities involved in the advertising business including publishers, advertisers, and exchanges, as well as any facilitating intermediaries in the transaction chain.

With respect to consumer value propositions, as mentioned, a value proposition for consumers is enabling management of their own online and offline commerce activity and enabling sharing of information about that activity with network services and ecosystems (“the cloud”) in return for an enhanced online service experience in the form of personalized search and better delivery of advertisements, as well as enhancing social networking and rewards scenarios. These scenarios are meant primarily to draw critical mass to adopt the platform and encourage the sharing of transactional data with the transaction and advertising platform, resulting in an explosion of consumer benefits and information benefits.

Representative, non-limiting examples include the provision of a personalized web services or portal experience (e.g., personalized Microsoft Live Experience), such as automatically tailored search, localized directories, tailored Maps experience, tailored experience for a mobile phone or other portable device, personalized shopping, personalized answers, and so on. The list of services available via one or more networks today that can benefit from knowing something but not everything about a consumer using the services is virtually endless.

For a specific, non-limiting scenario, search relevance can be enhanced significantly. For instance, by knowing a user's zip code, a search around “gas prices” can yield more relevant information for a consumer. For instance, instead of providing “gobbledygook” news articles discussing trends in gas prices due to Mexican suppression of output, search results can include an intelligent set of results that indicate to the consumer where the closest gas station is that provides the best price or value for gas. For instance, in addition to listing the closest gas station to the consumer 1 mile away that sells gas at a price of $3/gallon, the search results can also highlight a gas station that sells gas at a price of $2.75/gallon just 3 miles farther. In this regard, knowing something about the consumer performing the search yields vastly more relevant results.

For another non-limiting scenario, knowing about a consumer can also help the consumer organize his or her life. For instance, based on transaction history and knowledge of norms, a personal budgeting tool can be provided that makes suggestions to the consumer regarding which transactions are causing the budget to strain.

For another search example, recommendations can be made based on purchase history. For instance, FIG. 3 described above illustrates that if it is known that a consumer recently purchased a specific camera, and the consumer searches for “camera accessories,” accessories can be offered to the consumer that are relevant to or compatible with that specific camera (or related cameras). In addition, where it is known that the specific camera was purchased by the customer eons ago with no intervening camera purchases, the latest and greatest cameras that are far superior to the existing camera can be displayed to the consumer taking into account the age, commercial viability, etc. of the customer's existing camera.

Thus, generally, users make their online world more relevant to themselves compared to how irrelevant much of the information presented in search results is today. In this regard, an increase in relevance can improve the quality of search results at Windows Live Search, Windows Live Product Search and Windows Live Local based on your Live Rewards information. For instance, a Live Rewards service can enable a consumer to receive better targeted search results. As shown in the example, if the consumer has recently purchased a Canon A540 digital camera and the consumer searches for “Camera Accessories,” accessories relevant to the actual digital camera can be displayed. Similarly, if the consumer is searching for camera tripods, a user's favorite merchants can be displayed first, not necessarily the merchant who paid the most for the listing.

As another example, consumers participating in the platform can receive better targeting product communications. For instance, supposing a consumer is only one cup of coffee away from a free lunch at Starbucks as part of a customer loyalty or rewards program, the consumer can be shown relevant reminders through an online advertising network as the user surfs the Web.

In addition, along with the extra intelligence in providing search or other services, the consumer can be told why the offer is being presented, i.e., feedback. Thus, in the camera example, the consumer can be told that a subset of results relating to the recent purchase of the specific camera is being displayed because the consumer just purchased the camera. However, if the purchase was a gift for someone else, the consumer may not wish to see such related accessories and is thus given an opportunity to second guess the intelligence applied to the search and instead provide second or third choices, etc. for other intelligent search results, or no intelligence at all.

In addition, in connection with consumer oriented selling services, it may be helpful to know about an old camera so that the site can offer up a recommended selling price for the camera, or let the consumer know of an interested buyer. Thus, the consumer may consider a sale of an existing old item where the consumer knows of a buyer/price.

A service can also let a consumer know what a friend recently bought, or what a friend recommends. Thus, there is also a broad range of social networking applications and services that can be predicated on related user profiles and what one another's transactions reveal to each other.

Other intelligence can be applied not only to list a set of recommended items, but after purchase, a service can understand to relist the item and facilitate the sale of old or enhanced value items. For instance, after the purchase of some “hot concert tickets” at face value, if the price of those tickets sharply increases, a consumer may actually be tempted to sell the tickets if the price increases 10 times. In this regard, the number of scenarios is virtually limitless once a user profile and a user's transactions are understood with enough confidence.

Developing an understanding of users also facilitates the provision of targeted coupons, targeted discounts or other targeted incentives that a merchant may not wish to offer to the general population, but due to known characteristic(s) of a user, the merchant may be willing to facilitate a sale with a discount. For instance, a merchant may not wish to offer a lower price, or other discount, to unsophisticated consumers or, at the other end of the spectrum, extremely wealthy consumers, because there is no reason to believe that such consumers are price sensitive. In one embodiment, special offer pages can be generated on the fly or dynamically based on who the user is, i.e., the page itself and the offer(s) it represents can depend on the consumer viewing the page.

Similarly, loyalty programs or rewards programs can be tailored to particular consumers, or a much broader class of consumers than today, because not enough is understood about the consumers today. For instance, with airlines, typically a single inflexible tiered system is provided irrespective of who the consumer is. As an example, some airlines have loyalty programs that enable free travel after X number of segments or Y number of miles. However, just because a consumer falls short of such milestones does not necessarily mean the consumer cannot be incented to be loyal with something less than a full flight or shorter lines at the airport.

In general, rewards for various behaviors or purchases can also be tailored to the user. In this respect, a free tank of gas may have little applicability to a consumer that has no car, for instance. In such cases, a more suitable reward can be offered, such as a lesser cash equivalent award.

In this regard, a single tracking mechanism across the user's online and/or offline transaction history reveals a more powerful picture of who the user is.

In a broader perspective, aggregate data about a group of people and what they have in common enables a more powerful social world in which the system is actively learning information about common or shared goals of the group, and thus identify opportunities for individuals to grow within the group by understanding more about themselves and others within the group.

Trust, security and control over sensitive user and transaction data go hand in hand. The user should trust the system in order to actively participate. Security is beneficial towards creating trust so that third parties cannot compromise the data and control over the data by the user is part and parcel to establishing trust by enabling the consumer to define where others can see into their purchasing behavior and other profile information, and to define where the line of invisibility is at the same time in order to preserve privacy.

Today, mass distribution of promotional offers is performed according to a carpet-bombing technique where a massively overbroad audience is sent a mail, email, flyer, etc., which have little to no relevance to the viewer of the distribution. However, the mailer need only a small number of conversions on the distribution in order to make it worth the distributer's worthwhile. Accordingly, control over the distribution of offers, i.e., specifying which types of offers are OK and which are not, is provided in one embodiment.

A consumer can also configure data sharing in terms of the amount and kinds of data shared. In this respect, consumers are provided with a limitless digital locker in which their behavior, goods purchased and profile characteristics are stored. The consumer can expose anywhere from none of the information (in which case there is little or no benefit to being part of the ecosystem) to some to all of the information. Historically, any such control has been fragmented and presented to the consumer in a draconian fashion, i.e., either the consumer accepts the company's (e.g., a bank's) privacy policy and is allowed to be a customer as a result, or the consumer rejects the privacy policy and cannot participate as a customer as a result. In this regard, having a platform that supports such configuration of extent of user data sharing end to end is thus an advantage for the consumer. By exposing only the bits of information that the consumer wishes into the ecosystem, a much more relevant advertising experience is thereby achieved.

Fraud prevention measures are also taken by the platform to prevent consumer ID theft. Thus, in addition to having a secure platform that is not subject to third party compromise, certain kinds of information should not be persisted as part of the user profile. For instance, passport ID numbers are an example of data that might not be stored on a per user basis or as part of the user profile for that consumer so as to protect the identity of the user from nefarious uses.

Accordingly, a variety of representative scenarios have been illustrated above that enhance convenience for the consumer, making the consumer more likely to “give up” their personal information in exchange for a grander, more relevant and more convenient experience for the consumer.

For some additional broad categories of scenarios that are enabled by the platform, there are a variety of new ways to share with friends. For instance, where are coolest places to eat in one's neighborhood? Which movies are one's friends watching? What's the latest music trend in one's school? Which digital camera are one's colleagues buying? With enhanced rewards, one can choose to share one's loyalty experiences with friends within a set of contacts or other social circle. To the extent a consumer might be worried about privacy, one can decide what to share and what not to share. For instance, the user might want to publish restaurants visited in the last 6 months, but not coffee shops where the user typically does work and does not wish to be disturbed. It might be the opposite sharing scenario for another user. In short, different people have different privacy sensitivity profiles for different classes of information about them.

For another broader category, a “Review, Recommend, and Get Rewarded” scenario is enabled. For instance, with a rewards program predicated on the data exchange of the platform, one can easily recommend (for or against) places one has visited to a set of friends. Due to the comprehensive understanding of behavior from end to end about different users, the recommender is in a position to be rewarded. For an exemplary, non-limiting scenario, a user can visit Rewards.Live.Com, choose the store the user would like to recommend from a list of recent purchases and then select a set of recommendees (i.e., people to whom the store will be recommended) from the user's list of contacts or other defined social circle. Then, if the user's recommendees shop at that store, the user is rewarded.

For another broad category enabled by the platform, a user's friends can stay up to date with the user's purchases and behavior with various social networking actions enabled by the platform. For instance, a user can publish the user's latest cool finds via a blog, the user's FaceBook or MySpace page. As a result, the blog or page can automatically be updated when the user visits new restaurants or shops at the latest trendy stores depending on the user's share settings, i.e., the user still has control over what is published to the user's friends.

In another embodiment, the user selects how to be rewarded. For instance, with an embodiment of Windows Live Search, the user chooses how to be rewarded. For instance, if the user prefers American Airline miles as opposed to other airline programs, then the user visits Rewards.Live.Com and all of the purchases can be contributed towards a dream holiday. Another user may want points for songs for their MP3 player. The choice is in the hands of the consumer, and can be apportioned across different programs to achieve an optimal user balance.

In another embodiment, users can work together towards a common rewards goal. For instance, with Windows Live Circles and Windows Live Contacts, a user can set up a new Reward Pool for one's school, one's favorite charity, or that trip one wants to take overseas with friends. By encouraging others to register their Live Rewards program with the reward pool, everyone in the circle can work towards the unified goal. In this respect, all rewards, or a portion, can automatically be credited to the pool.

In addition, purchases can be tracked making it easier than ever for a user to holistically understand their spending habits. For an example implementation by Microsoft, with the richness of Windows Live Maps, Windows Live Local, Windows Live Search, Money management software and Office Live integration, it has never been easier to manage one's finances and spending patterns.

Another advantage to having a variety of services having access to the purchasing information is the ability to view one's recent purchases against a map program, such as Windows Live Maps. Thus, whenever one plots out a trip, such as a lengthy road trip, detailed maps can be generated based on past travels using transaction and reward information. For example, based on a user's transaction history, the map space can be translated into a parlance that is tailored to the user's local understanding and experiences. For instance, as a user develops a transaction history with brick and mortar establishments in an area, a set of directions can be transformed from “Turn left on 2^{nd} Ave in 0.3 miles” as generically rendered to a user today to something more useful and tailored to the user such as “Turn left on 2^{nd} Ave just after passing Benaroya Symphony Hall where you were last week.”

In other words, the vocabulary of maps and other map scenarios can be translated from a generic physical space to a physical space understood better understood by a specific user for whom the description is intended. The user may not remember what 2^{nd} Ave. looks like, but the user will remember what Benaroya Symphony Hall looks like if the user was there just last week. The generic information can also be displayed in the event that the user does not in fact recognize the customized information. Accordingly, as supplemental information, such customized information can only help a user navigate.

With respect to financial software, a user can import information directly into the data exchange platform and a variety of financial standby software can impart advantage to the user. For instance, Money, TurboTax and other leading personal financial management tools can automatically include much more detail of what has been purchased at supporting merchants. Benefits to merchants for participating are described in more detail below.

In another example, a user wishes to visit a store they discovered the other day, but the user does not remember exactly where it was located. Since the user bought an item at the store, with the platform described herein, the user can discover what store that was via their purchasing history, and then automatically print directions to the store at a click of a button or the like.

In another example similar to the above, the customer requires product support for a particular item purchased 2 weeks ago, or wishes to purchase additional numbers of the item. In one embodiment of a service, with Live Rewards contact information and directions to all of the places the user has visited, the relevant information can be placed at the user's fingertips.

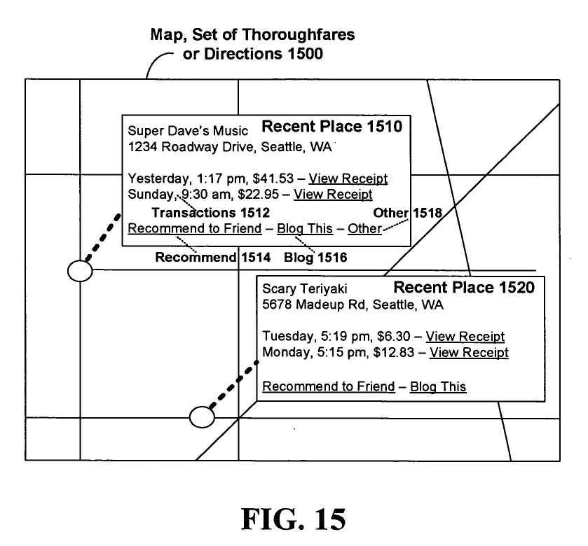

FIG. 15 is a representative non-limiting screenshot 1500 illustrating the power of the data of the ecommerce platform by enabling customized, tailored data to be delivered to a user on a map of interest to the user. Display 1500 may represent a map, a set of thoroughfares, or a part of a direction service (e.g., driving directions). With the enhanced understanding of users enabled by the aggregate user profile and transaction platform, places 1510, 1520, etc. can be displayed on the map 1500, which are places that are likely to be familiar with the user due to previous interaction with such places 1510, 1520, e.g., the user was recently at those places 1510, 1520. A recent place, such as recent place 1510, may include name info, address info, phone number, etc., but can also advantageously inform the user of transactions 1512 taken place at that place 1510. This helps to inform the user of why the place is on the map, and also at once brings recent spatial history of the user into memory of when the user was there, so that a target position on the map can be better understood in terms the user's specific interactions with the world. A user can recommend the place to friends via a social network service 1514, the user can add the place to a blog 1516, or take other actions 1518 on the place as part of the integrated map experience.

Another interesting scenario is viewing and/or printing one's receipts, such as with respect to items sold by merchants, or reordering supplies, e.g., toner, without visiting the store from which the associated printer was purchased.

Another scenario includes automatically registering products with the manufacturer of an item without having to enter in the information individually at every site where the user makes a purchase. Similarly, warranty information can be viewed for any item the user purchased. Oftentimes, it is difficult to know whether a broken product is covered by a warranty and so the ability to access the information at one's fingertips is valuable.

For merchant value propositions, as mentioned, in order to be of maximum utility, the platform should encourage participation by not just customers, but by merchants and other entities in the value chain as well. In this regard, one of the value propositions for merchants is through the sale of transactional data to the platform as well as through the sale of publishing inventory through the advertising exchange to drive other commerce-related services.

To enable the vibrant transaction and advertising platform ecosystem, the players in the ecosystem are provided with a set of well-defined interfaces to participate in the ecosystem.

For instance, a payments abstraction layer (PAL) can include a variety of already existing methods including secure hardware, payment method, payment provider and software-agnostic interfaces for the management of payment activities and financial events for IP enabled networks, supporting offline point of sale, back office and online payment scenarios.

In one embodiment, a rewards and loyalty abstraction layer (LAL) includes secure hardware, form, provider, usage policy agnostic interfaces for management of rewards and loyalty programs, including support coupons. The rewards and loyalty abstraction layer supports delivery of reward and loyalty information or entitlement, e.g., notification of reward or barcodes providing redemption opportunity. The layer enables a wide range of loyalty models such as merchant-centric rewards, payment card centric rewards, and redemption opportunity so that merchants merely define the rewards, given the standard interfaces and definitions for rewards, loyalty programs, coupons, how to redeem, etc.

The platform also includes an identity abstraction layer that includes secure hardware, form, provider and identity key agnostic interfaces for exchanging identity information including user authentication, user identification and user authorization information. The identity abstraction layer supports a wide range of identity keys such as phone number, card number, Windows Live Id, etc., which identify the user but do not compromise the actual identity of the user once stored as data in the data exchange of the platform.

Similarly, the platform includes a standard advertising abstraction layer of which merchants can take advantage including hardware, advertisers, advertising network and context-agnostic interfaces for the exchange of customer intelligence, inventory availability information, and delivery of advertisements in a wide range of media. The advertising abstraction layer can includes online advertising delivery and offline forms, such as back-of-receipt printing, text, audio, graphical and video advertisements.

In conjunction with developing and releasing a set of open interfaces for key commerce and advertising services, the platform provider can also include a proprietary online/hosted solution and data marketplace with additional value-add services, further reducing friction between merchants and service providers. In this respect, the transaction and advertising platform complements the abstraction layers in reducing friction for business on-boarding, enabling n-way transactions, data storage and management functionality.

Operating through the transaction and advertising platform rather than through collection of 2-way (merchant-service provider) direct relationships enables a range of scenarios—including data co-ops, n-way billing and independent service vendor (ISV) revenue share, cross-channel identity linking and new business models such as real-time service auctions.

This online service also represents opportunity for the platform provider itself to own the information collection point, which becomes a powerful monetization strategies for a wide range of industries where interesting customers or correlations are found among the aggregate data, particularly where there is a high degree of confidence for the data.

Other core components of the transaction and advertising platform service architecture can include: (A) a Data and Solutions Marketplace, (B) Scalable Identity Store supporting Multiple Identity Forms, (C) Scalable Transaction Data and Profile Store with Access/Usage Rights Management, (D) a Fuzzy targeting query engine, (E) Real-time Request Orchestration and/or (F) Service Rating and Billing Functionality, each of which in turn is described in more detail below.

With respect to the Data and Solutions Marketplace, a marketplace experience is enabled for participating service providers to show and sell their wares to participating merchants, as well as organize access and routing of transactions between the merchant and service providers. The marketplace provides a location for merchants to offer data (with usage rights) for sale to data consumers, such as risk management services, within the ecosystem.

As to providing a Scalable Identity Store supporting Multiple Identity Forms, the platform enables cross referencing of users between multiple merchants/payment providers as well as management of usage rights and exposing the capability to augment user profiles with additional data sources, such as Experian. Multiple identity forms can be supported to allow for offline identity collection, such as phone number, card number hash, etc., rather than limiting data collection to Windows Live Id or access network identifiers (ANIDs).

A Scalable Transaction Data and Profile Store with Access/Usage Rights Management provided with the platform enables transaction and identity data warehousing by participating merchants and service providers. This enables a range of store and forward data exchanges, such as Experian purchasing participating merchant data, as well as data analytics/data mining services to be provided within the solutions marketplace.

A fuzzy targeting query engine of the platform enables customization of advertising targeting segmentation using transactional, profile and inferred data.

The platform also includes Real-time Request Orchestration, which enables multi-party n-way transaction orchestration. A single request from a merchant may be routed to a risk management service, a data augmentation service, a payment provider and loyalty program, and further to the advertising exchange for a targeted ad placement on the resulting receipt—all in a single, aggregate response. This may result in merchant latency improvements, i.e., faster execution of strategy and changes in marketing tact, as well as reduced technical complexity for merchants.

Furthermore, this encourages new and diverse scenarios within the ecosystem. Similarly, rerouting services such as gradual transitions between service providers, fail-over request rerouting can reduce overall cost for merchants while increasing flexibility.

With respect to the platform's Service Rating and Billing Functionality, multi-party n-way bill calculation and settlement services are provided for merchants and service providers, enabling consolidated service provider relationships for merchants, e.g., one bill for all commerce activity, and allowing offsetting of expenses against potential income from the sale of data, data usage rights, publishing inventory, etc.

Accordingly, the platform has some rich incentives for both consumers and merchants alike to provide their data into the data exchange of the platform achieving a host of benefits in return for doing so. In addition, the platform provides incentives for advertising and publishing entities as well.

With respect to benefits to an advertising exchange built on the platform, building a common platform and service provider ecosystem provides a wide range of benefits to publishing and advertising entities that interface with an advertising exchange platform via advertising software and interfaces such as AdCenter. For instance, among these benefits include the collection of transaction and identity information, with usage rights for targeting and analytics.

Merchant usage permissions for this data can either be directly purchased, provided for in the Data Exchange terms of use (ToU) or purchased in conjunction with advertising publishing inventory. Consumer usage permissions may be gathered through Platform provider direct-to-consumer loyalty programs, service provider-hosted loyalty programs or gathered by the merchants themselves.

Another benefit is access to additional aggregate data with limited-usage rights transaction data for profiling. Where consumer usage permissions have not been gathered, such data may still be used and exchanged in aggregate form for general analytics, assisting in the development of behavioral targeting models and refining targeting for those consumers who have provided consent. There is also a demonstrated market for this information with manufacturers and distributers purchasing point of sale (POS) data from merchants in the offline world today.

Another benefit of the platform is the extension of advertising delivery reach to offline locations, such as touch screen devices, back of receipt printing, etc. As an example, participating merchants may play the role of an advertising publisher and directly extend the reach of commercial advertising software's, such as AdCenter's, contextual advertising network, thereby delivering targeted adverts to their customers at the point of sale in online and offline scenarios.

In addition, there are a host of value-add offerings for Merchant Advertisers and improved Advertiser “stickiness.” In this regard, a range of new value-add scenarios can be enabled, including advertising retargeting/cross and up-sell including retargeting for activities that were initiated in the offline space, or retargeting in the online space for activities initiated online. Another value add scenario includes coupon support, as well as support for loyalty and rewards programs to encourage consumer conversion.

In addition, the platform includes extended data analytics offerings, including profiling of a merchants existing customer base. The platform enables bundled service pricing, offset by data usage rights and the merchant's role as publisher. In addition, the platform enables consolidation of service provider relationships.

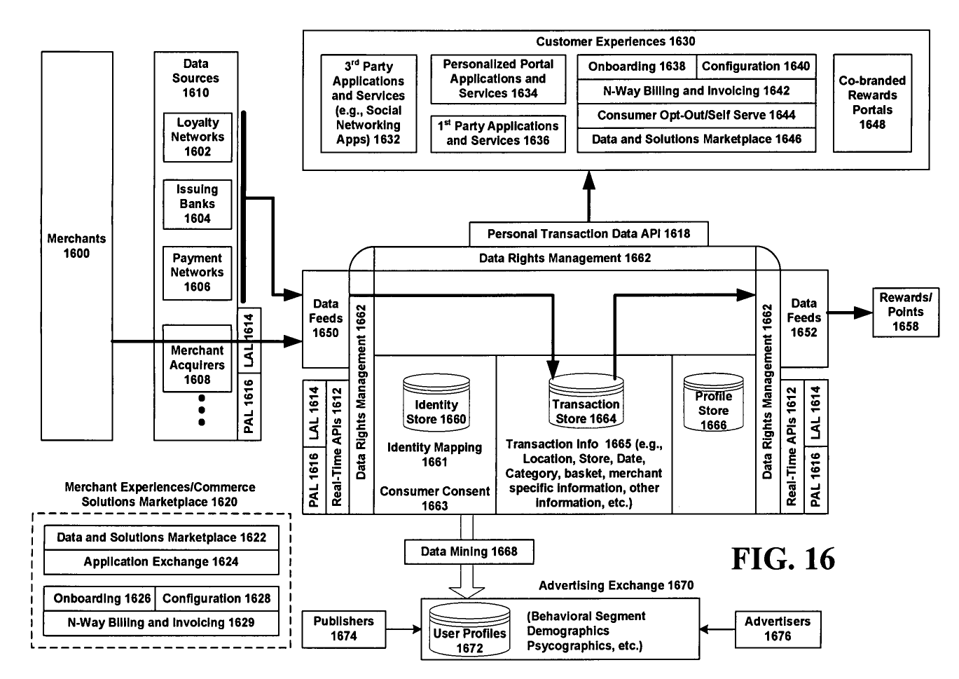

FIGS. 16 to 18 are exemplary non-limiting block diagrams of implementations of one or more aspects of an ecommerce platform according to one or more embodiments of an ecommerce platform described herein. It can be appreciated that such implementations include structure, flow and architectural relationships that can be achieved according to a variety of arrangements, and thus, should not be considered limiting on the scope of any ideas represented.

FIG. 16 illustrates the receipt of various data feeds 1650 by a platform from merchants 1600 and data sources 1610 including loyalty networks 1602, issuing banks 1604, payment networks 1606, merchant acquirers 1608, etc. Such data can be packaged according to a payment abstraction layer 1616 or according to a loyalty abstraction layer 1614, and any associated interfaces. Where PAL 1616 or LAL 1614 are provided in the diagram, this helps to standardize data for further processing one or more participants within the platform ecosystem. In some cases, real-time APIs 1612 are provided in conjunction with PAL 1616 or LAL 1614 such that the standardized data is of immediate use ready to satisfy real-time requirements of a service built on the incoming data. A data rights management wrapper 1662 enables users to control the use of their data by the platform by overseeing what is represented in the user store. As a result of greater control of their data, users are encouraged to provide more data.

The platform includes an identity store 1660 including identity mapping information 1661 and consumer consent information 1663. The platform further includes a transaction store 1664 in which various transaction information 1665 is stored, e.g., location, store, date, category, basket, merchant specific information, other information, etc. A user profile store 1665 is built up over time representing each unique identity, and from which classes of users can be discovered. From the platform, data feeds 1652 can be input and consumed to great value by rewards/points companies and services 1658 that wish to better understand users.

As mentioned, data mining 1668 can be applied to the stores 1660, 1664 and/or 1666 to extract further value, trends, categories, statistics, correlations, etc. in the data. The output of data mining 1668 can be used by an advertising exchange 1670 to enhance user profiles 1672 maintained by the advertising exchange 1670 in connection with targeting users to the benefit of publishers 1674 and advertisers 1676 alike who participate in the advertising exchange.

A set of rich experiences 1620 are also provided to merchants 1600 on top of the platform. For instance, as described above in more detail, a data and solutions marketplace 1622 includes an application exchange 1624 that exposes a variety of marketplace services to participating service providers, as well as onboarding component 1626, configuration component 1628 and a N-way billing and invoicing component 1629. Due to the comprehensive and concise representation of data about users enabled by the platform, a host of applications and services for participating merchants can thus be implemented via experiences 1620.

In addition, a host of services 1630 can be built for customers too. For instance, various 3^{rd} party applications and services 1632, such as social network applications, can be exposed to customers. First party services 1636, i.e., services integrated or otherwise related to the platform, can also be provided. Portal applications and services 1634, such as Live.com, can be personalized for customers to enrich the value for customers. Plus, similar to services provided to merchants, a data and solutions marketplace 1646 faces consumers and includes consumer opt-out/self serve functionality 1644, N-way billing and invoicing 1642, onboarding 1638 and/or configuration 1640. Various co-branded rewards portals 1648 can also be exposed to consumers via experiences 1630.

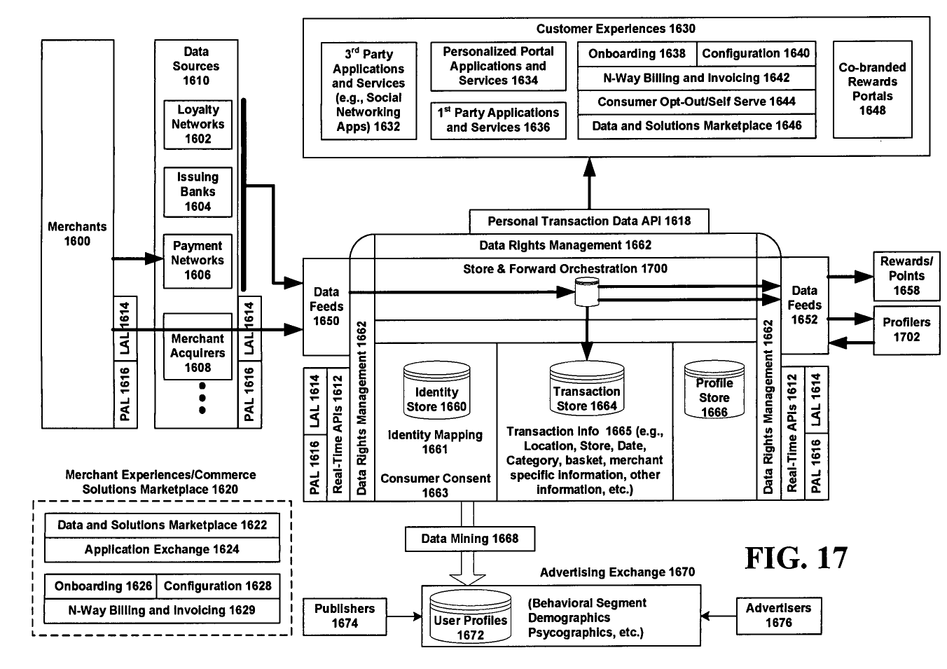

FIG. 17 illustrates an implementation similar to the implementation of FIG. 16. FIG. 17 additionally shows a store and forward orchestration component 1700 as part of the platform for handling end-to-end communications in the marketplace. Orchestration can be especially beneficial for real time services by component 1700 in connection with real time APIs 1612 where an application or service benefits from real time performance. Thus, certain kinds of information can be specified to be of interest in advance to the platform, so that upon receipt, the data is automatically extracted for immediate consumption by interested parties. FIG. 17 also illustrates that some companies independently collect profile data about users, in which case such entities 1702 are also interested in supplementing their data with data received from the platform, i.e., the data collected by the platform in its various forms is valuable to a variety of commerce players.

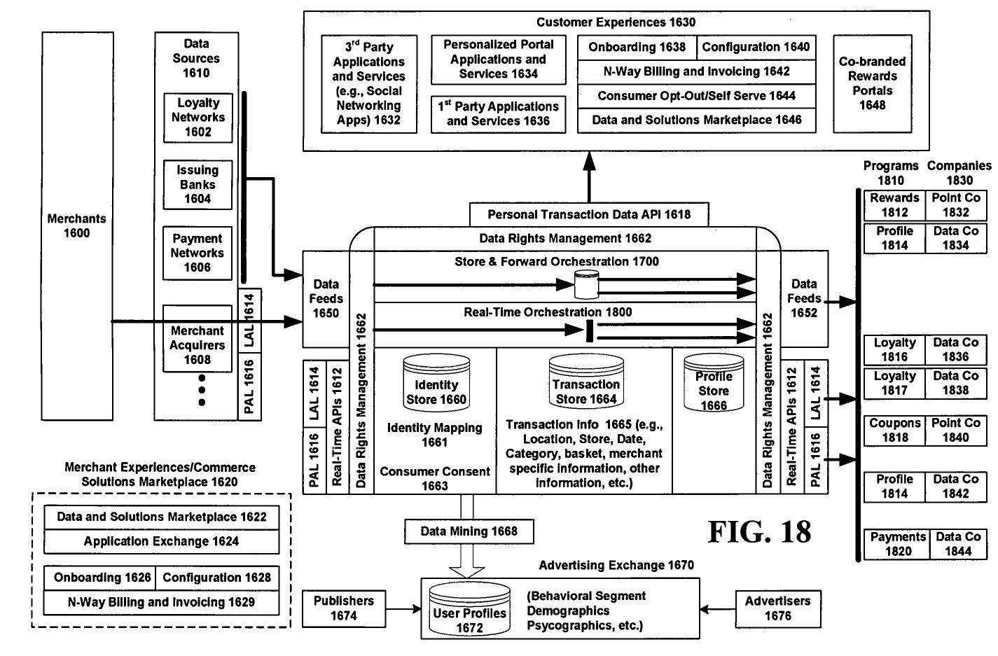

In the implementation of FIG. 18, a real-time orchestration component 1800 is illustrated that provide piping in the platform to carry out tasks, once relevant data is received via data feeds 1650 or via real-time APIs 1612, it can be routed automatically to various internal or external entities that require the data to meet a quality of service requirement. For instance, for some impulse based targeted advertising, the tight window might be required from the receipt of knowledge of a user transaction to the delivery of a targeted advertisement based on the user transaction. Thus, for services with real-time requirements, component 1800 can provide the plumbing and intelligence.

FIG. 18 further illustrates that a great variety of external businesses can benefit from the value of the information collected by the platform. For instance, data feeds 1652 can benefit a variety of programs 1810 offered by a variety of companies 1830, and can be provided in real time via real time APIs 1612. Example companies 1830 include point companies 1832, 1840 or data companies 1834, 1836, 1838, 1842, 1844. Example programs 1810 include rewards program 1812, profile service 1814, loyalty programs 1816, 1817, coupon program 1818, profile service 1814 or payment services 1820.

In an exemplary, non-limiting embodiment, the platform includes a standard set of interfaces for third parties to plug into in order to enable Data Collection by the platform. This can include one or more interfaces for collecting user data, i.e., information about users, collecting data about purchase transactions including data provided by merchants as well as user supplied data, collecting data about permissions and information rights management, collecting information about a payment instruments map, collecting information about rewards and/or collecting information about consumer actions. Actions data can include a history of actions, a map to rewards, and various uses as a social networking notification feeds.

Other non-limiting API Interfaces that can be implemented include a GetActionList interface that gets a list of a user's actions, a GetPurchaseHistory interface that gets a list of purchase history to be displayed to the user, a GetRewardHistory interface that displays a history of rewards to the user. Further, a GetSharedPurchases interface can get a list of purchases that a user chooses to share, a GetTotalRewards interface summarizes a view of a customer's rewards and a RegisterUser interface that initially registers the user into the transaction and advertising platform. Additionally, an UpdatePurchaseInfo interface can provide additional information on a particular purchase, set sharing permissions on the purchase and/or recommend/provide a rating for a purchase. Another interface can include WritePurchaseAction, which records user actions upon a purchase event.

Some non-limiting consumer services portal components can include a registration page, a display purchase history page, a display action history web part, a display social network history web part and/o links to common reference applications. In various respects and embodiments, a general protection over the use of transactional data is enabled, which return a whole host of enhanced informational, social, and rewards consumer scenarios.

For instance, in yet another embodiment, the platform extracts inferred information out of merchant descriptors or geography descriptors included in transaction data using semantic processes rather than mapping to an externally supplied knowledge store. For example, when the data exchange reads the following information from a descriptor “BEDBATH**1-800-555-BATH**SEATTLEWA,” the platform uses semantic interpretation to infer a meaning of “Bed Bath & Beyond, Seattle Wash., Phone number 1-800-555-2284”. The semantic analysis component determines whether one or more descriptors associated with the transaction data received by the data exchange represents inferable information based on semantic analysis of the one or more descriptors and then changes or augments the one or more descriptors based on the inferable information.

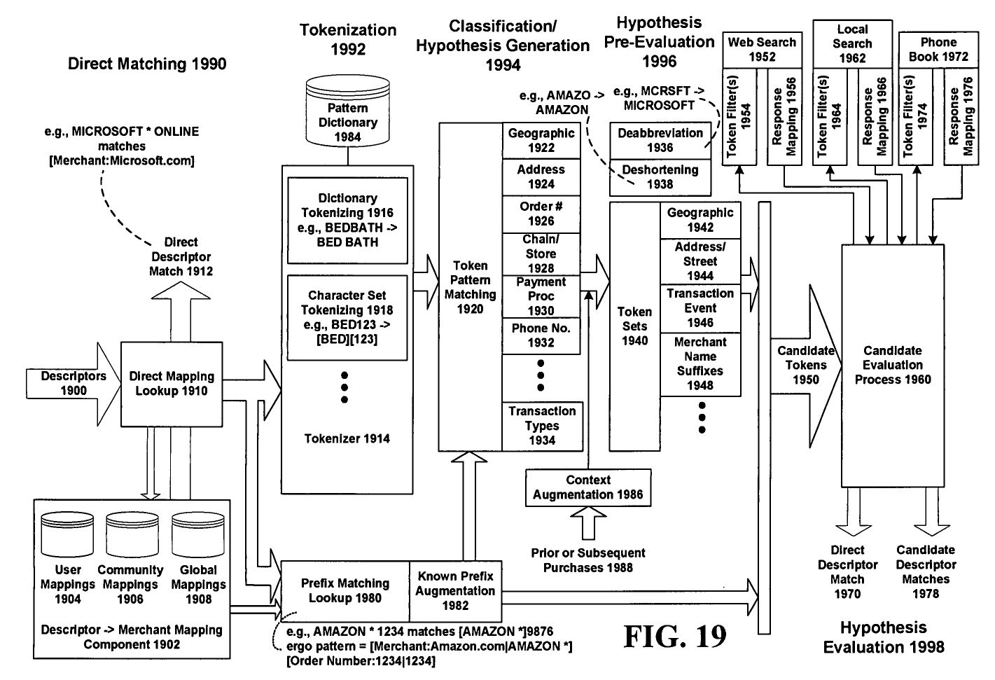

FIG. 19 is a block diagram of a non-limiting implementation of a process for resolving merchant descriptor information into a specific merchant reference, allowing the merchant descriptor information to be augmented with information from other data sources.

In general, merchant descriptors possess the following properties that can be factored into such an augmentation process. Merchant descriptors have very limited space for data and are often truncated descriptions as a result, or words compressed into one word, or otherwise abbreviated. Often merchant descriptors include compressed location information as well. For example, WAUS may represent Washington, United States, although no formal standards apply. Merchant descriptors may also invariably include phone, order information, chain/store identifiers/full merchant address or other geographic identities.

The system describes the following steps: direct matching 1990, tokenization 1992, classification/hypothesis generation 1994, hypothesis pre-evaluation 1996 and hypothesis evaluation 1998

Direct matching 1990 includes a direct mapping lookup component 1910 that initiates the process by looking for a direct match 1912 for descriptors 1900 against known flex descriptors, or prefix match 1980 against known flex descriptors, or known prefix augmentation 1982, via a descriptor to merchant mapping component 1902. These direct matches can be drawn from a universal mapping store 1908, community-provided mapping information 1906 or the user's own explicit feedback 1904.

Tokenization 1992 takes place via a tokenizer 1914 in consultation with a pattern dictionary 1984 which breaks down the flex descriptors into their component tokens, e.g., strings, spacers, numbers, symbols, etc. For flex descriptors, word separation may apply to facilitate searching. For instance, where a single ‘string’ can be represented by two well-known dictionary words appended together (for example, BEDBATH=BED+BATH), a second token set can be generated including “BED” and “BATH” for evaluation. Dictionary tokenizing component 1916 can handle the separation of words. Tokenizer 1914 can also include a character set tokenizing component 1918 to separate tokens into separate logical sub-tokens (e.g., characters separated from a numerical sequence).

With classification/hypothesis generation step 1994, a token pattern matching 1920 operates to receive the tokens from tokenizer 1914 and prefixes to form sets of tokens 1940 by classifying each token according to content. Numerous characteristics can be used, such as geographic characteristics 1922, addresses 1924, order numbers 1926, chain/store 1928, payment processor 1930, phone number 1932, transaction types 1934, etc. In addition to being classified in a context independent manner, the tokens can be augmented with context information as shown by component 1986 based on prior or subsequent related purchases 1988. Token length, patterns of tokens, e.g., XXX-XXX-XXXX, as well as position in token sequence, etc., can also be taken into account when forming token sets 1940. Token refinement can also include deabbreviation 1936 (e.g., MCRSFT→MICROSOFT) and deshortening 1938 (e.g., AMAZO→AMAZON) to further refine tokens.

Numerous classifications for token sets 1940 can result, e.g., geographic classifications 1942, street/address classifications 1944, transaction event classifications 1946, merchant name suffixes 1948, etc. Where a token matches a given classifier, a hypothesis is generated—for instance, the proposition that string XXX-XXX-XXXX is a phone number becomes a hypothesis, one of many passed through to pre-evaluation 1996 via candidate tokens 1950.

Under hypothesis pre-evaluation 1996, each hypothesis is tested according to known dictionaries of content/patterns to catch obvious misclassifications or obvious matches. For example, if the last token in the set is “US”, and a hypothesis proposes the last token is the country, then a check is performed against a list of known ISO country codes for a match. If no match is present, the hypothesis can be weighted down or dismissed, and vice versa for matches, i.e., their weight can be elevated.

At hypothesis evaluation 1998, a candidate evaluation process 1960 receives the candidates 1950 after pre-evaluation 1996 and the token strings, as refined, are fed to external information sources based on their classification (for example, phone numbers 1972 provided to yellow pages for reverse lookup) to check for matches against known merchants. Such sources may include yellow pages 1972, local search 1962, standard internet searching, 1952, and so on. Each source, such as web search 1952, local search 1962 and phone book 1972 include the ability to receive tokens as filters 1954, 1964 and 1974, respectively, and the ability to return a response 1956, 1966 and 1976, respectively, based on the tokens received. The confidence of the resulting matches decides the final hypothesis that is selected as the correct one 1970, and associated with that hypothesis a reference to the full merchant details (name, address, etc), as illustrated by candidate descriptor matches 1978.

In another embodiment, a method is implemented in the exchange for calculating a reward value to be returned to a user for supplying missing or correcting data based on the increase in confidence value that the additional data will give to the data point. For instance, the data exchange may receive transaction data from one or more transactions conducted with a variety of merchants and then semantically analyze merchant or geography descriptors included in the transaction data to ascertain supplemental information about a merchant or location associated with the transaction data. As a result, the merchant descriptors and/or geography descriptors can be augmented or modified based on the supplemental information.

In another embodiment, because of the integrity of the transaction data and user profiles aggregated by the ecommerce platform, the platform also exposes a set of APIs to developers of third party applications that enables them to build applications and services that make use of user transactional data based on permissions and present them in alternative ways. In one implementation, an electronic commerce platform includes a data exchange for aggregating transaction data from both online and offline payment transactions conducted by users. On top of the transaction data store, a set of application programming interfaces (APIs) enable third party applications to access the transaction data according to a variety of pre-defined forms that allow access to the transaction data to third party applications in accordance with a set of permissions granted individually to the third party applications including permissions granted by users.

In still another embodiment, an electronic commerce platform is provided that has a data exchange for aggregating user transaction data, including financial statement data, pertaining to both online and offline payment transactions conducted by users. Advantageously, a filter for the data is provided that identifies and discards non-commercial information included in the user transaction data received by the data exchange. For example, in a debit card statement, the platform does not typically benefit from line items on financial statements, such as withdrawals or credit card payments, since they represent transactions that are not for goods or services. This illustrates that some types of transactions merely represent a zero sum game by a user since it is money transferring from one account to another, or to or from a user's pocket, but represents no commercial transaction per se and thus is of interest to an aggregate user transaction data store.

### Exemplary Networked and Disturbed Environments

One of ordinary skill in the art can appreciate that the various embodiments of user profiling and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

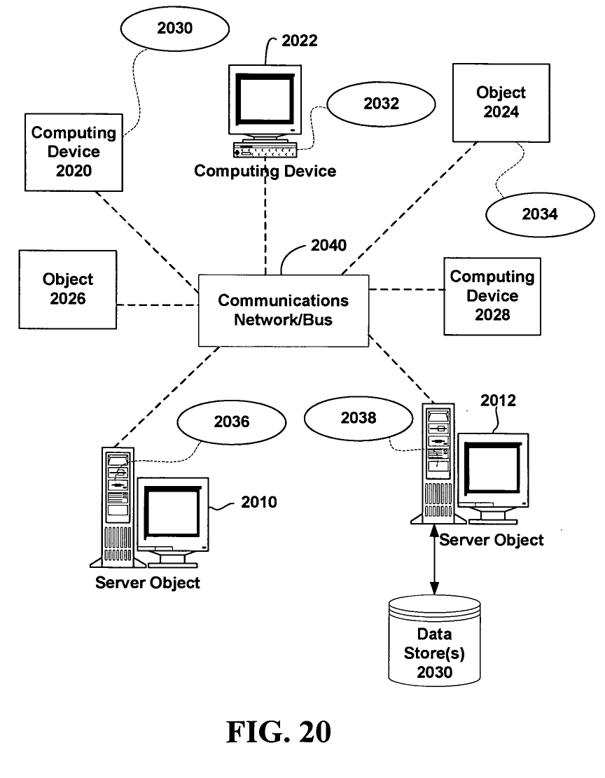

FIG. 20 provides a non-limiting schematic diagram of an exemplary networked or distributed computing environment. The distributed computing environment comprises computing objects 2010, 2012, etc. and computing objects or devices 2020, 2022, 2024, 2026, 2028, etc., which may include programs, methods, data stores, programmable logic, etc., as represented by applications 2030, 2032, 2034, 2036, 2038. It can be appreciated that objects 2010, 2012, etc. and computing objects or devices 2020, 2022, 2024, 2026, 2028, etc. may comprise different devices, such as PDAs, audio/video devices, mobile phones, MP3 players, personal computers, laptops, etc.

Each object 2010, 2012, etc. and computing objects or devices 2020, 2022, 2024, 2026, 2028, etc. can communicate with one or more other objects 2010, 2012, etc. and computing objects or devices 2020, 2022, 2024, 2026, 2028, etc. by way of the communications network 2040, either directly or indirectly. Even though illustrated as a single element in FIG. 20, network 2040 may comprise other computing objects and computing devices that provide services to the system of FIG. 20, and/or may represent multiple interconnected networks, which are not shown. Each object 2010, 2012, etc. or 2020, 2022, 2024, 2026, 2028, etc. can also contain an application, such as applications 2030, 2032, 2034, 2036, 2038, that might make use of an API, or other object, software, firmware and/or hardware, suitable for communication with or implementation of the user profiling in a transaction and advertising platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 20, as a non-limiting example, computers 2020, 2022, 2024, 2026, 2028, etc. can be thought of as clients and computers 2010, 2012, etc. can be thought of as servers where servers 2010, 2012, etc. provide data services, such as receiving data from client computers 2020, 2022, 2024, 2026, 2028, etc., storing of data, processing of data, transmitting data to client computers 2020, 2022, 2024, 2026, 2028, etc., although any computer can be considered a client, a server, or both, depending on the circumstances. Any of these computing devices may be processing data, or requesting services or tasks that may implicate the improved user profiling and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 2040 is the Internet, for example, the servers 2010, 2012, etc. can be Web servers with which the clients 2020, 2022, 2024, 2026, 2028, etc. communicate via any of a number of known protocols, such as the hypertext transfer protocol (HTTP). Servers 2010, 2012, etc. may also serve as clients 2020, 2022, 2024, 2026, 2028, etc., as may be characteristic of a distributed computing environment.

### Exemplary Computing Device

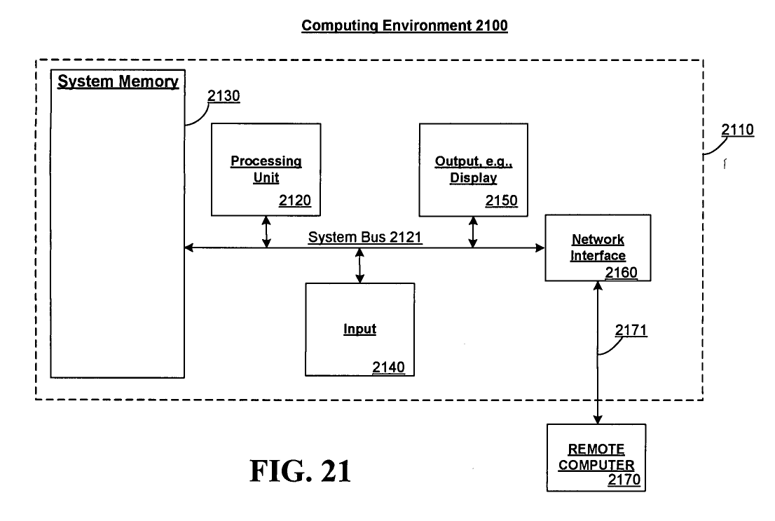

As mentioned, various embodiments described herein apply to any device wherein it may be desirable to perform user profiling. It should be understood, therefore, that handheld, portable and other computing devices and computing objects of all kinds are contemplated for use in connection with the various embodiments described herein, i.e., anywhere that a device may request commerce platform services for a network address in a network. Accordingly, the below general purpose remote computer described below in FIG. 21 is but one example, and the embodiments of the subject disclosure may be implemented with any client having network/bus interoperability and interaction. Additionally, the user profiling component can include itself include one or more aspects of the below general purpose computer.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 21 thus illustrates an example of a suitable computing system environment 2100 in which one or more of the embodiments may be implemented, although as made clear above, the computing system environment 2100 is only one example of a suitable computing environment and is not intended to suggest any limitation as to the scope of use or functionality of any of the embodiments. Neither should the computing environment 2100 be interpreted as having any dependency or requirement relating to any one or combination of components illustrated in the exemplary operating environment 2100.

With reference to FIG. 21, an exemplary remote device for implementing one or more embodiments herein can include a general purpose computing device in the form of a computer 2110. Components of computer 2110 may include, but are not limited to, a processing unit 2120, a system memory 2130, and a system bus 2121 that couples various system components including the system memory to the processing unit 2120.

Computer 2110 typically includes a variety of computer readable media and can be any available media that can be accessed by computer 2110. The system memory 2130 may include computer storage media in the form of volatile and/or nonvolatile memory such as read only memory (ROM) and/or random access memory (RAM). By way of example, and not limitation, memory 2130 may also include an operating system, application programs, other program modules, and program data.

A user may enter commands and information into the computer 2110 through input devices 2140 A monitor or other type of display device is also connected to the system bus 2121 via an interface, such as output interface 2150. In addition to a monitor, computers may also include other peripheral output devices such as speakers and a printer, which may be connected through output interface 2150.

The computer 2110 may operate in a networked or distributed environment using logical connections to one or more other remote computers, such as remote computer 2170. The remote computer 2170 may be a personal computer, a server, a router, a network PC, a peer device or other common network node, or any other remote media consumption or transmission device, and may include any or all of the elements described above relative to the computer 2110. The logical connections depicted in FIG. 21 include a network 2171, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to derive advertising value.

There are multiple ways of implementing one or more of the embodiments described herein, e.g., an appropriate API, tool kit, driver code, operating system, control, standalone or downloadable software object, etc. which enables applications and services to use the advertising and commerce platform services of the invention. Embodiments may be contemplated from the standpoint of an API (or other software object), as well as from a software or hardware object that provides commerce platform services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for generating a user profile from aggregate transaction data for a participant in an electronic commerce and advertising platform, comprising:
for each transaction represented by the aggregate transaction data, assigning at least one confidence value to at least a subset of the transaction information; and
generating at least one user profile from the aggregate transaction data as a function of the at least one confidence value of the transaction information represented by the transactions of the aggregate transaction data.

2. The method of claim 1, further including:
determining at least one performance metric associated with the performance of the at least one user profile; and
calibrating the at least one confidence value based on the at least one performance metric of the at least one user profile.

3. The method of claim 1, further including:
receiving additional data reflecting an accuracy of the at least a subset of the transaction information; and
calibrating the at least one confidence value based on the additional data.

4. The method of claim 3, further including:
increasing the at least one confidence value based on receiving confirming data that supports the accuracy of the at least a subset of the transaction information.

5. The method of claim 3, further including:
decreasing the at least one confidence value based on receiving conflicting data that conflicts with the at least a subset of the transaction information.

6. The method of claim 1, further including:
calibrating the at least one confidence value based on receipt of confirmation or denial of the at least one confidence value by the user represented by the at least one user profile.

7. The method of claim 6, further including:
substantially increasing the at least one confidence value based on receipt from the user of explicit confirmation of the at least a subset of the transaction information.

8. The method of claim 6, further including:
substantially decreasing the at least one confidence value based on receipt from the user of explicit denial of the at least a subset of the transaction information.

9. The method of claim 1, wherein the generating includes updating a formerly generated user profile as a function of the at least one confidence value of the transaction information represented by the transactions of the aggregate transaction data.

10. An electronic commerce platform, comprising:
a data exchange for aggregating user transaction data from online and offline transactions conducted by users where at least one data element of at least one transaction of the online and offline transactions is at least one of uncertain, incomplete or missing; and
a fuzzy profiling component communicatively coupled to the data exchange that assigns one or more confidence values to the user transaction data based on one or more degrees of certainty associated with at least one data element of the user transaction data relating to the at least one data element being at least one of uncertain, incomplete or missing,
wherein the fuzzy profiling component takes the one or more confidence values into account when updating a user profile for the user based on the user transaction data.

11. The electronic commerce platform of claim 10, further comprising:
a query service communicatively coupled to the data exchange that receives queries based on a defined level of confidence for the results and that takes the one or more confidence values into account when outputting query results.

12. The electronic commerce platform of claim 10, wherein the fuzzy profiling component assigns the one or more confidence values based on a confidence associated with a source of the user transaction data, or a source of one or more data elements of the user transaction data.

13. The electronic commerce platform of claim 10, wherein the fuzzy profiling component assigns the one or more confidence values to the user transaction data based on one or more degrees of certainty relating to the at least one data element being uncertain.

14. The electronic commerce platform of claim 10, wherein the fuzzy profiling component assigns the one or more confidence values to the user transaction data based on one or more degrees of certainty relating to the at least one data element being incomplete.

15. The electronic commerce platform of claim 10, wherein the fuzzy profiling component assigns the one or more confidence values to the user transaction data based on one or more degrees of certainty relating to the at least one data element being missing.

16. The electronic commerce platform of claim 10, further including:
a privacy control component that enables individual users to explicitly control the further use of the individual users' transaction data as represented by the updated user profile.

17. A method for mapping raw transactional data to unique user identities, comprising:
receiving from a plurality of different data providers at least one raw transaction dataset representing transaction data from one or more transactions conducted by a variety of users;
for each transaction represented by the transaction data, transforming the transaction by applying at least one common taxonomy to the transaction data including applying preset data mappings and conversions to the transaction data;
analyzing each transaction of the transaction data including inferring additional data to be added to the transaction data associated with the transaction;
adding the inferred additional data to the transaction data to form processed transaction data having at least one attribute; and
mapping each transaction to a unique identifier associated with an individual user identity based on one or more of the at least one attribute of the processed transaction data.

18. The method of claim 17, further comprising:
inferring a relationship between transactions of the processed transaction data; and
cross referencing the transactions of the processed transaction data having the inferred relationship.

18. The method of claim 17, further comprising:
based on user preference, disabling sharing of information represented by transaction data associated with the individual user identity in at least one pre-defined sharable data category, whereby the information is not shared with other participants of an electronic commerce platform.

19. The method of claim 17, further comprising:
based on user authorization, enabling sharing of information represented by transaction data associated with the individual user identity with respect to at least one sharable attribute of transactions to enable sharing of the information with other participants of an electronic commerce platform.

20. The method of claim 17, further comprising:
for each transaction represented by the transaction data, identifying whether the transaction includes non-commercial transaction data; and
removing the non-commercial transaction data from the transaction data prior to storing by the electronic commerce platform.
